(19) United States
(12) Patent Application Publication
(10) Pub. No.: US 2016/0134840 A1
(43) Pub. Date: May 12, 2016

(54) Avatar-Mediated Telepresence Systems with Enhanced Filtering

(71) Applicant: Alexa Margaret McCulloch, Punta Gorda, FL (US)

(72) Inventor: Alexa Margaret McCulloch, Punta Gorda, FL (US)

(21) Appl. No.: 14/810,400

(22) Filed: Jul. 27, 2015

Related U.S. Application Data
(60) Provisional application No. 62/030,058, filed on Jul. 28, 2014.
(60) Provisional application No. 62/030,059, filed on Jul. 28, 2014.
(60) Provisional application No. 62/030,060, filed on Jul. 28, 2014.
(60) Provisional application No. 62/030,061, filed on Jul. 28, 2014.
(60) Provisional application No. 62/030,062, filed on Jul. 28, 2014.
(60) Provisional application No. 62/030,063, filed on Jul. 28, 2014.
(60) Provisional application No. 62/030,064, filed on Jul. 28, 2014.
(60) Provisional application No. 62/030,065, filed on Jul. 28, 2014.
(60) Provisional application No. 62/030,066, filed on Jul. 29, 2014.
(60) Provisional application No. 62/031,978, filed on Aug. 1, 2014.
(60) Provisional application No. 62/031,985, filed on Aug. 1, 2014.
(60) Provisional application No. 62/031,995, filed on Aug. 1, 2014.
(60) Provisional application No. 62/032,000, filed on Aug. 1, 2014.
(60) Provisional application No. 62/033,745, filed on Aug. 6, 2014.

(51) Int. Cl. H04N 7/15; H04N 7/14

(52) U.S. Cl. CPC H04N 7/157; H04N 7/142

(57) ABSTRACT

Methods and systems using photorealistic avatars to provide live interaction. Several groups of innovations are described. In one such group, trajectory information included with the avatar model makes the model 4D rather than 3D. In another group, a fallback representation is provided with deliberately-low quality. In another group, avatar fidelity is treated as a security requirement. In another group, avatar representation is driven by both video and audio inputs, and audio output depends on both video and audio input. In another group, avatar representation is updated while in use, to refine representation by a training process. In another group, avatar representation uses the best-quality input to drive avatar animation when more than one input is available, and swapping to a secondary input while the primary input is insufficient. In another such group, the avatar representation can be paused or put into a standby mode.

### CROSS-REFERENCE

Priority is claimed from U.S. patent applications 62/030,058, 62/030,059, 62/030,060, 62/030,061, 62/030,062, 62/030,063, 62/030,064, 62/030,065, 62/030,066, 62/031,978, 62/033,745, 62/031,985, 62/031,995, and 62/032,000, all of which are hereby incorporated by reference.

### BACKGROUND

The present application relates to communications systems, and more particularly to systems which provide completely realistic video calls under conditions which can include unpredictably low bandwidth or transient bandwidth.

Note that the points discussed below may reflect the hindsight gained from the disclosed inventions, and are not necessarily admitted to be prior art.

Video Communications

Business and casual travel have increased dramatically over the past decades. Further, advancements in communications technology places video conferencing capabilities in the hands of the average person. This has led to more video calls and meetings by video conference. Moreover, this increase in video communication regularly occurs over multiple time zones, and allows more people to work remotely from their place of business.

However, technical issues remain. These include dropped calls, bandwidth limitations and inefficient meetings that are disrupted when technology fails.

The present application also teaches that an individual working remotely has inconveniences that have not been appropriately addressed. These include, for example, extra effort to find a quiet, peaceful spot with an appropriate backdrop, effort to ensure one's appearance is appropriate (e.g., waking early for a middle-of-the night call, dressing and coiffing to appear alert and respectful), and background noise considerations.

Broadband-enabled forms of transportation are becoming more prevalent—from the subway, to planes to automobiles. There are privacy issues, transient lighting issues as well as transient bandwidth issues. However, with improved access, users are starting to see out solutions.

Entertainment Industry

Current computer-generated (CG) animation has limitations. It takes hours to weeks to build a single lifelike human 3D animation model. 3D animation models are processor intensive, require massive amounts of memory and are large files and programs in themselves. However, today's computers are able to capture and generate acceptable static 3D models which are lifelike and avoid the Uncanny Valley.

Motion-capture technology is used to translate actors' movements and facial expressions onto computer-animated characters. It is used in military, entertainment, sports, medical applications, and for validation of computer vision and robotics.

Traditionally, in motion capture, the filmmaker places around 200 sensors on a person's body and a computer tracks how the distances between those sensors change in order to record three-dimensional motion. This animation data is mapped to a 3D model so that the model performs the same actions as the actor.

However, the use of motion capture markers slows the process and is highly distracting to the actors.

Security Issues

The security industry is always looking for better ways to identify hazards, potential liabilities and risks. This is especially true online where there are user verification and trust issues. There is a problem with paedophiles and underage users participating in games, social media and other online activities. The fact that they are able to hide their identity and age is a problem for the greater population.

Healthcare Industry

Caregivers in the healthcare industry, especially community nurses and travelling therapists, expend a lot of time travelling to see patients. However, administrators seek a solution that cuts down on travel time and associated costs, while maintaining a personal relationship with patients.

Additionally, in more remote locations where telehealth and telemedicine are an ideal solution, there are coverage, speed and bandwidth issues as well as problems with latency and dropouts.

### SUMMARY OF MULTIPLE INNOVATIVE POINTS

The present application describes a complex set of systems, including a number of innovative features. Following is a brief preview of some, but not necessarily all, of the points of particular interest. This preview is not exhaustive, and other points may be identified later in hindsight. Numerous combinations of two or more of these points provide synergistic advantages, beyond those of the individual inventive points in the combination. Moreover, many applications of these points to particular contexts also have synergies, as described below.

The present application teaches building an avatar so lifelike that it can be used in place of a live video stream on conference calls. A number of surprising aspects of implementation are disclosed, as well as a number of surprisingly advantageous applications. Additionally, these inventions address related but different issues in other industries.

Telepresence Systems Using Photorealistic Fully-Animated 3D Avatars Synchronized to Sender's Voice, Face, Expressions and Movements

This group of inventions uses processing power to reduce bandwidth demands, as described below.

Systematic Extrapolation of Avatar Trajectories During Transient/Intermittent Bandwidth Reduction

This group of inventions uses 4-dimensional trajectories to fit the time-domain behavior of marker points in an avatar-generation model. When brief transient dropouts occur, this permits extrapolation of identified trajectories, or substitute trajectories, to provide realistic appearance.

Fully-Animated 3D Avatar Systems with Primary Mode Above Uncanny-Valley Resolutions and Fallback Mode Below Uncanny-Valley Resolutions

One of the disclosed groups of inventions is an avatar system which provides a primary operation with realism above the “uncanny valley,” and which has a fallback mode with realism below the uncanny valley. This is surprising because the quality of the fallback mode is deliberately limited. For example, the fallback transmission can be a static transmission, or a looped video clip, or even a blurred video transmission—as long as it falls below the “Uncanny Valley” criterion discussed below.

In addition, there is also a group of inventions where an avatar system includes an ability to continue animating an avatar during pause and standby modes by displaying either predetermined animation sequences or smoothing the transition from animation trajectories when pause or standby is selected to those used during these modes.

Systems Using 4-Dimensional Hair Emulation and De-Occlusion.

This group of inventions applies to both static and dynamic hair on the head, face and body. Further it addresses occlusion management of hair and other sources.

Avatar-Based Telepresence Systems with Exclusion of Transient Lighting Changes

Another class of inventions solves the problem of lighting variation in remote locations. After the avatar data has been extracted, and the avatar has been generated accordingly, uncontrolled lighting artifacts have disappeared.

User-Selected Dynamic Exclusion Filtering in Avatar-Based Systems.

Users are preferably allowed to dynamically vary the degree to which real-time video is excluded. This permits adaptation to communications with various levels of trust, and to variations in available channel bandwidth.

Immersive Conferencing Systems and Methods

By combining the sender-driven avatars from different senders, a simulated volume is created which can preferably be viewed as a 3D scene.

Intermediary and Endpoint Systems with Verified Photorealistic Fully-Animated 3D Avatars

As photorealistic avatar generation becomes more common, verification of avatar accuracy can be very important for some applications. By using a real-time verification server to authenticate live avatar transmissions, visual dissimulation is made detectable (and therefore preventable).

Secure Telepresence Avatar Systems with Behavioral Emulation and Real-Time Biometrics

The disclosed systems can also provide secure interface. Preferably behavioral emulation (with reference to the trajectories used for avatar control) is combined with real-time biometrics. The biometrics can include, for example, calculation of interpupillary distance, age estimation, heartrate monitoring, and correlation of heartrate changes against behavioral trajectories observed. (For instance, an observed laugh, or an observed sudden increase in muscular tension might be expected to correlate to shifts in pulse rate.)

Markerless Motion Tracking of One or More Actors Using 4D (dynamic 3D ) Avatar Model

Motion tracking using the real-time dynamic 3D (4D) avatar model enables real-time character creation and animation and eliminates the need for markers, resulting in markerless motion tracking.

Multimedia Input and Output Database

These inventions provide for a multi-sensory, multi-dimensional database platform that can take inputs from various sensors, tag and store them, and convert the data into another sensory format to accommodate various search parameters.

Audio-Driven 3D Avatar

This group of inventions permit a 3D avatar to be animated in real-time using live or recorded audio input, instead of video. This is a valuable option, especially in low bandwidth or low light conditions, where there are occlusions or obstructions to the user's face, when available bandwidth drops too low, when the user is in transit, or when video stream is not available. It is preferred that a photorealistic/lifelike avatar is used, wherein these inventions allow the 3D avatar to look and sound like the real user. However, any user-modified 3D avatar is acceptable for use.

This has particularly useful applications in communications, entertainment (especially film and video gaming), advertising, education and healthcare. Depending on the authentication parameters, it also applies to security and finance industries.

In the film industry, not only can markerless motion tracking be achieved, but by the simple reading of line, the avatar is animated. This means less time may be required in front of a green screen for small script changes.

Lip Reading Using 3D Avatar Model

The present group of inventions provide for outputs that: emulate the sound of the user's voice, produce modified audio (e.g. lower pitch or change accent from American to British), convert the audio to text, or translate from one language to another (e.g. Mandarin to English).

The present inventions have particular applications to the communications and security industries. More precisely, circumstances where there are loud backgrounds, whispers, patchy audio, frequency interferences, or when there is no audio available. These inventions can be used to augment interruptions in audio stream(s) (e.g. where audio drops out; too much background noise such as barking dog, construction, coughing, screaming kids; interference in the line)

Overview and Synergies

The proposed inventions feature a lifelike 3D avatar that is generated, edited and animated in real-time using markerless motion capture. One embodiment sees the avatar as the very likeness of the individual, indistinguishable from the real person. The model captures and transmits in real-time every muscle twitch, eyebrow raise and even the slightest smirk or smile. There is an option to capture every facial expression and emotion.

The proposed inventions include an editing (“vanity”) feature that allows the user to “tweak” any imperfections or modify attributes. Here the aim is permit the user to display the best version of the individual, no matter the state of their appearance or background.

Additional features include biometric and behavioral analysis, markerless motion tracking with 2D, 3D, Holographic and neuro interfaces for display.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 is a block diagram of an exemplary system for real-time creation, animation and display of 3D avatar.

FIG. 2 is a block diagram of a communication system that captures inputs, performs calculations, animates, transmits, and displays an avatar in real-time for one or more users on local and remote displays and speakers.

FIG. 3 is a flow diagram that illustrates a method for creating, animating and communicating via an avatar.

FIG. 4 is a flow diagram illustrating a method for creating the avatar using only video input in real-time.

FIG. 5 is a flow diagram illustrating a method of creating an avatar using both video and audio input.

FIG. 6 is a flow diagram illustrating a method for defining regions of the body by relative range of motion and/or complexity to model.

FIG. 7 is a flow diagram that illustrates a method for modeling hair and hair movement of the avatar.

FIG. 8 is a flow diagram that illustrates a method for capturing eye movement and behavior.

FIG. 9 is a flow diagram illustrating a method for real-time modifying a 3D avatar and its behavior.

FIG. 10 is a flow diagram illustrating a method for real-time updates and improvements to a dynamic 3D avatar model.

FIG. 11 is a flow diagram of a method that adapts to physical and/or behavioral changes of the user.

FIG. 12 is a flow diagram of a method to minimize an audio dataset.

FIG. 13 is a flow diagram illustrating a method for filtering out background noises, including other voices.

FIG. 14 is a flow diagram illustrating a method to handle with occlusions.

FIG. 15 is a flow diagram illustrating a method to animate an avatar using both video and audio inputs to output video and audio.

FIG. 16 is a flow diagram illustrating a method to animate an avatar using only video input to output video, audio and text.

FIG. 17 is a flow diagram illustrating a method to animate an avatar using only audio input to output video, audio and text.

FIG. 18 is a flow diagram illustrating a method to animate an avatar by automatically selecting the highest quality input to drive animation, and swapping to another input when a better input reaches sufficient quality, while maintaining ability to output video, audio and text.

FIG. 19 is a flow diagram illustrating a method to animate an avatar using only text input to output video, audio and text.

FIG. 20 is a flow diagram illustrating a method to select a different background.

FIG. 21 is a flow diagram illustrating a method for animating more than one person in view.

FIG. 22 is a flow diagram illustrating a method to combine avatars animated in different locations or on different local systems into a single view or virtual 3D space.

FIG. 23 is a flow diagram illustrating two users communicating via avatars.

FIG. 24 is a flow diagram illustrating a method for sample outgoing execution.

FIG. 25 is a flow diagram illustrating a method to verify dataset quality and transmission success.

FIG. 26 is a flow diagram illustrating a method for extracting animation datasets and trajectories on a receiving system, where the computations are done on the sender's system.

FIG. 27 is a flow diagram illustrating a method to verify and authenticate a user.

FIG. 28 is flow diagram illustrating a method to pause the avatar or put it in standby mode.

FIG. 29 is a flow diagram illustrating a method to output from the avatar model to a 3D printer.

FIG. 30 is a flow diagram illustrating a method to output from the avatar model to non-2D displays.

FIG. 31 is a flow diagram illustrating a method to animate and control a robot using a 3D avatar model.

### DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The present application discloses and claims methods and systems using photorealistic avatars to provide live interaction. Several groups of innovations are described.

According to one of the groups of innovations, trajectory information is included with the avatar model, so that the avatar model is not only 3D, but is really four-dimensional.

According to one of the groups of innovations, a fallback representation is provided, but with the limitation that the quality of the fallback representation is limited to fall below the “uncanny valley” (whereas the preferred avatar-mediated representation has a quality higher than that of the “uncanny valley”). Optionally the fallback can be a pre-selected animation sequence, distinct from live animation, which is played during pause or standby mode.

According to another one of the groups of innovations, the fidelity of the avatar representations is treated as a security requirement: while a photorealistic avatar improves appearance, security measures are used to avoid impersonation or material misrepresentations. These security measures can include verification, by an intermediate or remote trusted service, that the avatar, as compared with the raw video feed, avoids impersonation and/or meets certain general standards of non-misrepresentation. Another security measure can include internal testing of observed physical biometrics, such as interpupillary distance, against purported age and identity.

According to another one of the groups of innovations, the avatar representation is driven by both video and audio inputs, and the audio output is dependent on the video input as well as the audio input. In effect, the video input reveals the user's intentional changes to vocal utterances, with some milliseconds of reduced latency. This reduced latency can be important in applications where vocal inputs are being modified, e.g. to reduce the vocal impairment due to hoarseness or fatigue or rhinovirus, or to remove a regional accent, or for simultaneous translation.

According to another one of the groups of innovations, the avatar representation is updated while in use, to refine representation by a training process.

According to another one of the groups of innovations, the avatar representation is driven by optimized input in real-time by using the best quality input to drive avatar animation when there is more than one input to the model, such as video and audio, and swapping to a secondary input for so long as the primary input fails to meet a quality standard. In effect, if video quality fails to meet a quality standard at any point in time, the model automatically substitutes audio as the driving input for a period of time until the video returns to acceptable quality. This optimized substitution approach maintains an ability to output video, audio and text, even with alternating inputs. This optimized hybrid approach can be important where signal strength and bandwidth fluctuates, such as in a moving vehicle.

According to another one of the groups of innovations, the avatar representation can be paused or put into a standby mode, while continuing to display an animated avatar using predefined trajectories and display parameters. In effect, a user selects pause mode when a distraction arises, and a standby mode is automatically entered whenever connection is lost or the input(s) fails to meet quality standard.

3D avatars are photorealistic upon creation, with options to edit or fictionalize versions of the user. Optionally, computation can be performed on local device and/or in the cloud.

In the avatar-building process, key features are identified using recognition algorithms, and user-unique biometric and behavioral data are captured, to build dynamic model.

The system must be reliable and outputs must be of acceptable quality.

A user can edit their own avatar, and has the option to save and choose from several saved versions. For example, a user may prefer a photorealistic avatar with slight improvements for professional interactions (e.g. smoothing, skin, symmetry, weight). Another option for the same user is to drastically alter more features, for example, if they are participating in an online forum and wish to remain anonymous. Another option includes fictionalizing the user's avatar.

A user's physical and behavior may change over time (e.g. Ageing, cosmetic surgery, hair styles, weight). Certain biometric data will remain unchanged, while other parts of the set may have been altered dues to ageing or other reasons. Similarly, certain behavioral changes will occur over time as a result of ageing, an injury or changes to mental state. The model may be able to captures these subtleties, which also generates valuable data that can be mined and used for comparative and predictive purposes, including predicting the current age of particular use.

Occlusions

Examples of occlusions include glasses, bangs, long flowing hair, hand gestures, whereas examples of obstructions include virtual reality glasses such as the Oculus Rift. It is preferred for the user to initially create the avatar without any occlusions or obstructions. One option is to use partial information and extrapolate. Another option is to use additional inputs, such as video streams, to augment datasets.

Lifelike Hair Movement and Management

Hair is a complex attribute to model. First, there is facial hair: eyebrows, eyelashes, mustaches, beards, sideburns, goatees, mole hair, and hair on any other part of the face or neck. Second, there is head hair, which varies in length, amount, thickness, straight/curliness, cut, shape, style, textures, and combinations. Then, there are the colors—in facial hair and head hair, which can single or multi-toned, individual strands differing from others (e.g. gray), roots different from the ends, highlights, lowlights and so very many possible combinations. Add to that, hair accessories range from ribbons to barrettes to scarves to jewelry (in every color, cloth, plastic, metal and gem imaginable).

Hair can be grouped into three categories: facial hair, static head hair, and dynamic head hair. Static head hair is the only one that does not have any secondary movement (e.g. it moves with the head and skin itself). Facial hair, while generally short, experiences movements with the muscles of the face. In particular, eyelashes and eyebrows generally move, in whole or in part, several times every few seconds. In contrast, dynamic hair, such as a woman's long hair or even a long man's beard, will move in a more fluid manner and requires more complex modeling algorithms.

Hair management options include using static hair only, applying a best match against a database and adjusting for differences, and defining special algorithms to uniquely model the user's hair.

Another consideration is that dynamic hair can obscure a user's face, requiring augmentation or extrapolation techniques when animating an avatar. Similarly, a user with an obstructed face (e.g. due to viewing glasses such as Oculus Rift) will require algorithmic modelling to drive the hair movement in lieu of full datasets.

User's will be provided with option to improve their hair, including style, color, shine, extending (bringing receding hairline to original location). Moreover, some users may elect to save different edits groups for use in the future (e.g. professional look vs. party look).

The hair solution can be extended to enable users to edit their look to appear with hair on their entire face and body, such that can become a lifelike animal or other furry creature.

Markerless Motion Tracking of One or More Actors Using 4D (dynamic 3D ) Avatar Model

This group of inventions only requires a single camera, but has options to augment with additional video stream(s) and other sensor inputs. No physical markers or sensors are required.

The 4D avatar model distinguishes the user from their surroundings, and in real-time generates and animates a lifelike/photorealistic 3D avatar. The user's avatar can be modified while remaining photorealistic, but can also be fictionalized or characterized. There are options to adjust scene integration parameters including lighting, character position, audio synchronization, and other display and scene parameters: automatically or by manual adjustment.

Multi-Actor Markerless Motion Tracking in Same Field of View

When more than one actor is to be tracked in the same field of view, a 4D (dynamic 3D ) avatar is generated for each actor. There are options to maintain individual records or composites records. An individual record allows for the removal of one or more actors/avatars from the scene or to adjust the position of each actor within the scene. Because biometrics and behaviors are unique, the model is able to track and capture each actor simultaneously in real-time.

Multi-Actor Markerless Motion Tracking Using Different Camera Inputs (Separate Fields of View)

The disclosed inventions allow for different camera(s) to used to create the 4D (3D dynamic) avatar for each actor. In this case, each avatar is considered a separate record, but can be composited together automatically or adjusted by the user to adjust for spatial position of each avatar, background and other display and output parameters. Similarly, such features as lighting, sound, color and size are among details that can be automatically adjusted or manually tweaked to enable consistent appearance and synchronized sound.

An example of this is the integration of three separate avatar models into the same scene. The user/editor will want to ensure that size, position, light source and intensity, sound direction and volume and color tones and intensities are consistent to achieve believable/acceptable/uniform scene.

For Self-Contained Productions:

If the user desires to keep the raw video background, the model simply overlays the avatar on top of the existing background. In contrast, if the user would like to insert the avatar into a computer generated 3D scene or other background, the user selects or inputs the desired background. For non-stationary actors, it is preferred that the chosen background also be modelled in 3D.

For Export (to be Used with External Software/Program/Application):

The 4D (dynamic 3D ) model is able to output the selected avatar and features directly to external software in a compatible format.

Multimedia Input and Output Database

A database is populated by video, audio, text, gesture/touch and other sensory inputs in the creation and use of dynamic avatar model. The database can include all raw data, for future use, and options include saving data in current format, selecting the format, and compression. In addition, the input data can be tagged appropriately. All data will be searchable using algorithms of both the Dynamic (4D) and Static 3D model.

The present inventions leverage the lip reading inventions wherein the ability exists to derive text or an audio stream from a video stream. Further, the present inventions employ the audio-driven 3D avatar inventions to generate video from audio and/or text.

These inventions provide for a multi-sensory, multi-dimensional database platform that can take inputs from various sensors, tag and store them, and convert the data into another sensory format to accommodate various search parameters.

Example: User queries for conversation held at a particular date and time, but wants output to be displayed as text.

Example: User wants to view audio component of telephone conversation via avatar to better review facial expressions.

Other options include searching all formats for X, and want output to be text or another format. This moves us closer to the Star Trek onboard computer.

Another option is to query the database across multiple dimensions, and/or display results across multiple dimensions.

Another optional feature is to search video &/or audio &/or text and compare and offer suggestions regarding similar “matches” or to highlight discrepancies from one format to the other. This allows for improvements to the model, as well as urge the user to maintain a balanced view and prevent them from becoming solely reliant on one format/dimension and missing the larger “picture”.

Audio-Driven 3D Avatar

There are several options to the present group of inventions, which include: an option to display text in addition to the “talking avatar”; an option for enhanced facial expressions and trajectories to be derived from the force or intonation and volume of audio cues; option to integrate with lip reading capabilities (for instances when audio stream may drop out or for enhanced avatar performance), and another option is for the user to elect to change the output accent or language that is transmitted with the 3D avatar.

Lip Reading Using 3D Avatar Model

An animated lifelike/photorealistic 3D avatar model is used that captures the user's facial expressions, emotions, movements and gestures. The dataset captured can be done in real-time or from recorded video stream(s).

The dataset includes biometrics, cues and trajectories. As part of the user-initiated process to generate/create the 3D avatar, it is preferred that the user's audio is also captured. The user may be required to read certain items aloud including the alphabet, sentence, phrases, and other pronunciations. This enables the model to learn how the user sounds when speaking, and the associated changes in facial appearance with these sounds. The present group of inventions provides for outputs that: emulate the sound of the user's voice, produce modified audio (e.g. lower pitch or change accent from American to British), convert the audio to text, or translate from one language to another (e.g. Mandarin to English).

For avatars that are not generated with user input (e.g. CCTV footage), there is an option to use a best match approach using a database that is populated with facial expressions and muscle movements and sounds that have already been “learned”/correlated. There are further options to automatically suggest the speaker's language, or to select from language and accent options, or manually input other variables.

The present inventions have particular applications to the communications and security industries. More precisely, circumstances where there are loud backgrounds, whispers, patchy audio, frequency interferences, or when there is no audio available.

These inventions can be used to augment interruptions in audio stream(s) (e.g. where audio drops out; too much background noise such as barking dog, construction, coughing, screaming kids; interference in the line)

Video Communications

Business and casual travel have increased dramatically over the past decades. Further, advancements in communications technology places video conferencing capabilities in the hands of the average person. This has led to more video calls and meetings by video conference. Moreover, this increase in video communication regularly occurs over multiple time zones, and allows more people to work remotely from their place of business.

However, technical issues remain. These include dropped calls due to bandwidth limitations and inefficient meetings that are disrupted when technology fails.

Equally, an individual working remotely has inconveniences that have not been appropriately addressed. These include, extra effort to find a quiet, peaceful spot with an appropriate backdrop, effort to ensure one's appearance is appropriate (e.g., waking early for a middle-of-the night call, dressing and coiffing to appear alert and respectful), and background noise considerations.

Combining these technology frustrations with vanity issues demonstrates a clear requirement for something new. In fact, there could be a massive uptake of video communications when a user is happy with his/her appearance and background.

Broadband enabled forms of transportation are becoming more prevalent—from the subway, to planes to automobiles. There are privacy issues, transient lighting issues as well as transient broadwidth issues. However, with improved access, users are starting to see out solutions.

Holographic/walk-around projection and 3D “skins” transforms the meaning of “presence”.

Entertainment Industry

Current computer-generated (CG) animation has limitations. It takes hours to weeks to build a single lifelike human 3D animation model. 3D animation models are processor intensive, require massive amounts of memory and are large files and programs in themselves. However, today's computers are able to capture and generate acceptable static 3D models which are lifelike and avoid the Uncanny Valley.

Motion-capture technology is used to translate an actors' movements and facial expressions onto computer-animated characters. It is used in military, entertainment, sports, medical applications, and for validation of computer vision and robotics.

Traditionally, in motion capture, the filmmaker places around 200 sensors on a person's body and a computer tracks how the distances between those sensors change in order to record three-dimensional motion. This animation data is mapped to a 3D model so that the model performs the same actions as the actor.

However, the use of motion capture markers slows the process and is highly distracting to the actor.

Security Issues

The security industry is always looking for better ways to identify hazards, potential liabilities and risks. This is especially true online. There is a problem with paedophiles and underage users participating in games, social media and other online activities. The fact that they are able to hide their age is a problem for the greater population.

Users display unique biometrics and behaviors in a 3D context, and this data is powerful form of identification.

Healthcare Industry

Caregivers in the healthcare industry, especiall community nurses and travelling therapists expend a lot of time travelling to see patients. However, administrators seek a solution that cuts down on travel time and associated costs, while maintaining a personal relationship with patients.

Additionally, in more remote locations where telehealth and telemedicine are the ideal solution, there are bandwidth issues and problems with latency.

Entertainment Industry

Content providers in the film, TV and gaming industry are constantly pressured to minimize costs, and expedite production.

Social Media and Online Platforms

From dating sites to bloggers to social media, all desire a way to improve their relationships with their users. Especially the likes of pornography, who have always pushed the advancements on the internet.

Transforming the Education Industry

With the migration of and inclusion of online learning platforms, teachers and administrators are looking for ways to integrate and improve communications between students and teachers.

Implementations and Synergies

The present application discloses technology for lifelike, photorealistic 3D avatars that are both created and fully animated in real-time using a single camera. The application allows for inclusion of 2D, 3D and stereo cameras. However, this does not preclude the use of several video streams, and more than camera is allowed. This can be implemented with existing commodity hardware (e.g. smart phones, tablets, computers, webcams).

The present inventions extend to technology hardware improvements which can include additional sensors and inputs and outputs such as neuro interfaces, haptic sensors/outputs, other sensory input/output.

Embodiments of the present inventions provide for real-time creation of, animation of, AND/OR communication using photorealistic 3D human avatars with one or more cameras on any hardware, including smart phones and tablet computers.

One contemplated implementation uses a local system for creation and animation, which is then networked to one or more other local systems for communication.

In one embodiment, a photorealistic 3D avatar is created and animated in real-time using a single camera, with modeling and computations performed on the user's own device. In another embodiment, the computational power of a remote device or the Cloud can be utilized. In another embodiment, the avatar modeling is performed on a combination of the users local device and remotely.

One contemplated implementation uses the camera and microphone built into a smartphone, laptop or tablet computer to create a photorealistic 3D avatar of the user. In one embodiment, the camera is a single lens RGB camera, as is currently standard on most smartphones, tablets and laptops. In other embodiments, the camera is a stereo camera, a 3D camera with depth sensor, a 360°, a spherical (or partial) camera or a wide variety of other camera sensors and lenses.

In one embodiment, the avatar is created with live inputs and requires interaction with the user. For example when creating the avatar, the user is requested to move their head as directed, or simply look-around, talk and be expressive to capture enough information to capture the likeness of the user in 3D. In one embodiment, the input device(s) are in a fixed position. In another embodiment, the input device(s) are not in a fixed position such as, for example, when a user is holding a smartphone in their hand.

One contemplated implementation makes use of a generic database, which is referenced to improve the speed of modeling in 3D. In one embodiment, such database can be an amalgamation of several databases for facial features, hair, modifications, accessories, expressions and behaviors. Another embodiment references independent databases.

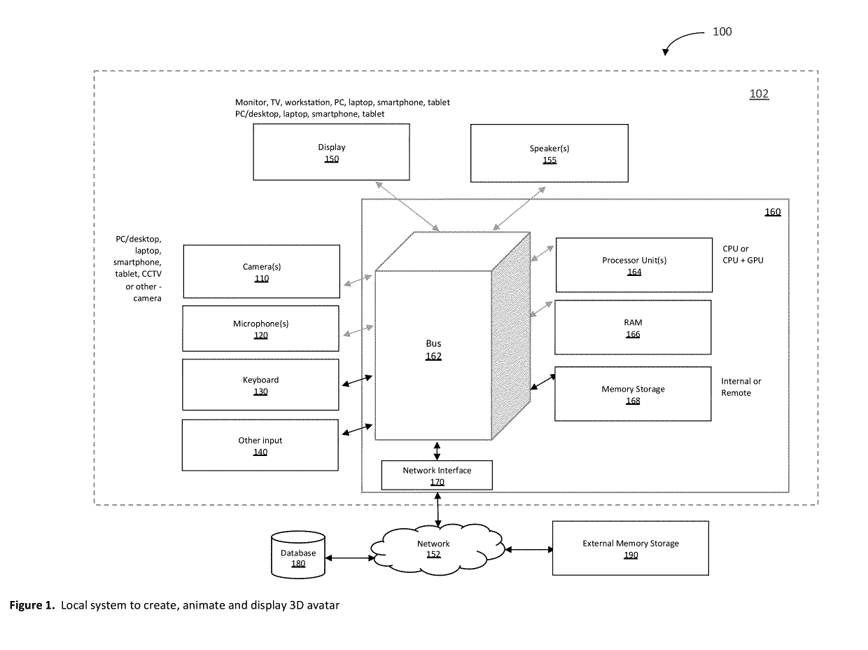

FIG. 1 is a block diagram of an avatar creation and animation system 100 according to an embodiment of the present inventions. Avatar creation and animation system depicted in FIG. 1 is merely illustrative of an embodiment incorporating the present inventions and is not intended to limit the scope of the inventions as recited in the claims. One of ordinary skill in the art would recognize other variations, modifications, and alternatives.

In one embodiment, avatar creation and animation system 100 includes a video input device 110 such as a camera. The camera can be integrated into a PC, laptop, smartphone, tablet or be external such as a digital camera or CCTV camera. The system also includes other input devices including audio input 120 from a microphone, a text input device 130 such as a keyboard and a user input device 140. In one embodiment, user input device 140 is typically embodied as a computer mouse, a trackball, a track pad, wireless remote, and the like. User input device 140 typically allows a user to select and operate objects, icons, text, avatar characters, and the like that appear, for example, on the display 150. Examples of display 150 include computer monitor, TV screen, laptop screen, smartphone screen and tablet screen.

The inputs are processed on a computer 160 and the resulting animated avatar is output to display 150 and speaker(s) 155. These outputs together produce the fully animated avatar synchronized to audio.

The computer 160 includes a system bus 162, which serves to interconnect the inputs, processing and storage functions and outputs. The computations are performed on processor unit(s) 164 and can include for example a CPU, or a CPU and GPU, which access memory in the form of RAM 166 and memory devices 168. A network interface device 170 is included for outputs and interfaces that are transmitted over a network such as the Internet. Additionally, a database of stored comparative data can be stored and queried internally in memory 168 or exist on an external database 180 and accessed via a network 152.

In one embodiment, aspects of the computer 160 are remote to the location of the local devices. One example is at least a portion of the memory 190 resides external to the computer, which can include storage in the Cloud. Another embodiment includes performing computations in the Cloud, which relies on additional processor units in the Cloud.

In one embodiment, a photorealistic avatar is used instead of live video stream for video communication between two or more people.

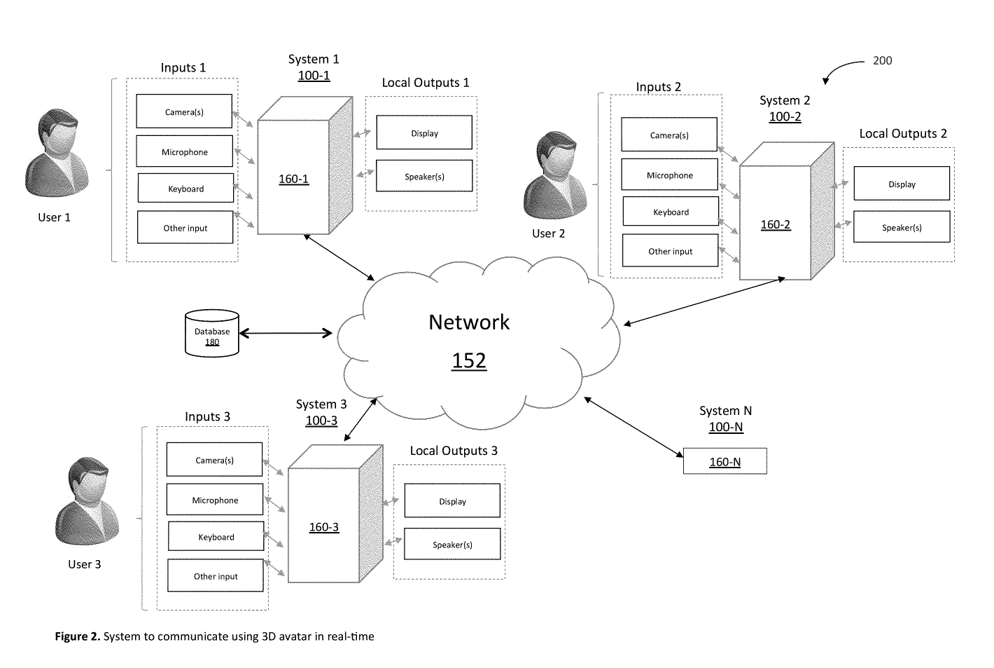

FIG. 2 is a block diagram of a communication system 200, which captures inputs, performs calculations, animates, transmits, and displays an avatar in real-time for one or more users on local and remote displays and speakers. Each user accesses the system from their own local system 100 and connects to a network 152 such as the Internet. In one embodiment, each local system 100 queries database 180 for information and best matches.

In one embodiment, a version of the user's avatar model resides on both the user's local system and destination system(s). For example, a user's avatar model resides on user's local system 100-1 as well as on a destination system 100-2. A user animates their avatar locally on 100-1, and the model transmits information including audio, cues and trajectories to the destination system 100-2 where the information is used to animate the avatar model on the destination system 100-2 in real-time. In this embodiment, bandwidth requirements are reduced because minimal data is transmitted to fully animate the user's avatar on the destination system 100-2.

In another embodiment, no duplicate avatar model resides on the destination system 100-2 and the animated avatar output is streamed from local system 100-1 in display format. One example derives from displaying the animated avatar on the destination screen 150-2 instead of live video stream on a video conference call.

In one embodiment, the user's live audio stream is synchronized and transmitted in its entirety along with the animated avatar to destination. In another embodiment, the user's audio is condensed and stripped of inaudible frequencies to reduce the output audio dataset.

Creation-Animation-Communication

There are a number of contemplated implementations described herein. One contemplated implementation distinguishes between three different phases, each of which are conducted in real-time, can be performed in or out of sequence, in parallel or independently, and which are avatar creation, avatar animation and avatar communication. In one embodiment, avatar creation includes editing the avatar. In another embodiment, it is a separate step.

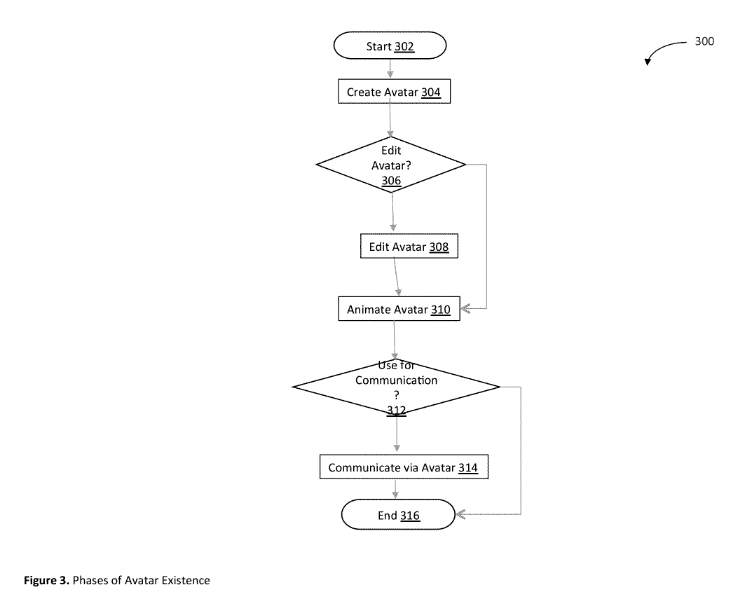

FIG. 3 is a flow diagram that illustrates a method for creating, animating and communicating via an avatar. The method is stepped into at step 302. At step 304, an avatar is created. In one embodiment, a photorealistic avatar is created that emulates both the physical attributes of the user as well as the expressions, movements and behaviors. At step 306, an option is given to edit the avatar. If selected, the avatar is edited at step 308.

At step 310, the avatar is animated. In one embodiment, steps 304 and 310 are performed simultaneously, in real-time. In another embodiment, steps 306 and 308 occur after step 310.

At step 312, an option is given to communicate via the avatar. If selected, then at step 314, communication protocols are initiated and each user is able to communicate using their avatar instead of live video and/or audio. For example, in one embodiment, an avatar is used in place of live video during a videoconference.

If the option at step 312 is not selected, then only animation is performed. For example, in one embodiment, when the avatar is inserted into a video game or film scene, the communication phase may not be required.

The method ends at step 316.

In one contemplated implementation, each of steps 304, 308, 310 and 314 can be performed separately, in different sequence and/or independently with the passing of time between steps.

Real-Time 3D Avatar Creation

One contemplated implementation for avatar creation requires only video input. Another contemplated implementation requires both video and audio inputs for avatar creation.

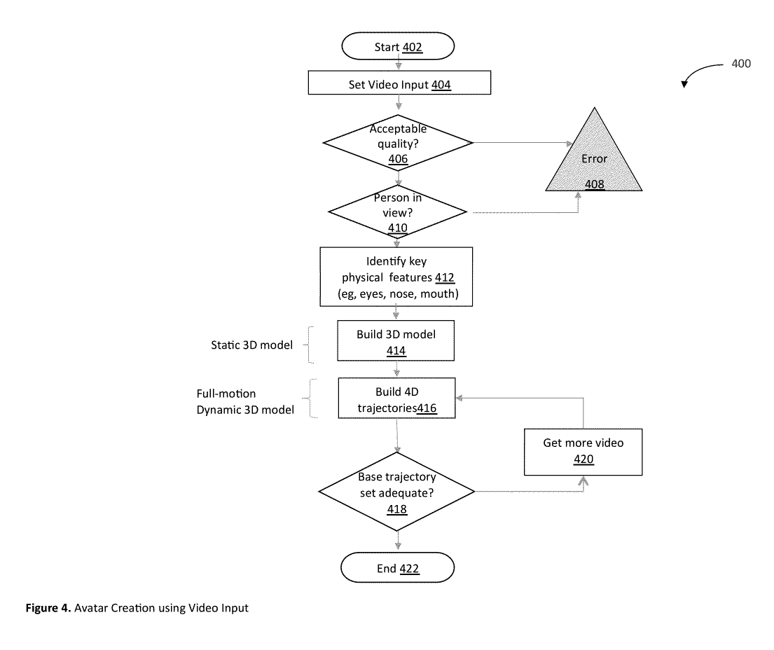

FIG. 4 is a flow diagram illustrating a method for creating the avatar using only video input in real-time. Method 400 can be entered into at step 402, for example when a user initiates local system 100, and at step 404 selects input as video input from camera 110. In one embodiment, step 404 is automatically detected.

At step 406, the system determines whether the video quality is sufficient to initiate the creation of the avatar. If the quality is too poor, the operation results in an error 408. If the quality is good, then at step 410 it is determined if a person is in camera view. If not, then an error is given at step 408. For example, in one embodiment, a person's face is all that is required to satisfy this test. In another embodiment, the full head and neck must be in view. In another embodiment, the whole upper body must be in view. In another embodiment, the person's entire body must be in view.

In on embodiment, no error is given at step 408 if the user steps into and/or out of view, so long as the system is able to model the user for a minimum combined period of time and/or number of frames at step 410.

In one embodiment, if it is determined that there is more than one person in view at step 410, then a user can select which person to model and then proceed to step 412. In another embodiment, when there is more than one person in view, the method assumes that simultaneous models will be created for each person and proceeds to step 410.

If a person is identified at step 410, then key physical features are identified at step 412. For example, in one embodiment, the system seeks to identify facial features such as eyes, nose and mouth. In another embodiment, head, eyes, hair and arms must be identified.

At step 414, the system generates a 3D model, capturing sufficient information to fully model the requisite physical features such as face, body parts and features of the user. For example, in one embodiment only the face is required to be captured and modeled. In another embodiment the upper half of the person is required, including a full hair profile so more video and more perspectives are required to capture the front, top, sides and back of the user.

Once the full 3D model is captured, a full-motion, dynamic 3D (4D) model is generated at step 416. This step builds 4D trajectories that contain the facial expressions, physical movements and behaviors.

In one embodiment, steps 414 and 416 are performed simultaneously.

A check is performed at step 418 to determine if the base trajectory set is adequate. If the base trajectory set is not adequate, then at step 420 more video is required to build new trajectories at step 416.

Once the user and their behavior have been sufficiently modeled, the method ends at step 422.

Including Audio During Avatar Creation: Mapping Voice and Emotion Cues

In one embodiment, both audio and video are used to create an avatar model, and the model captures animation cues from audio. In another embodiment, audio is synchronized to the video at input, is passed through and synchronized to the animation at output.

In one embodiment, audio is filtered and stripped of inaudible frequencies to reduce the audio dataset.

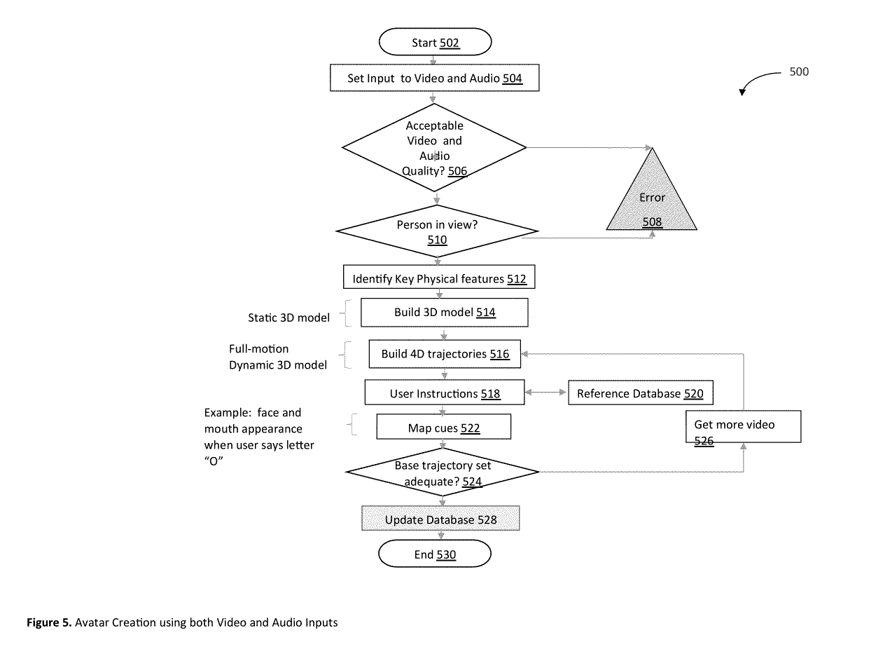

FIG. 5 is a flow diagram illustrating a method 500 of generating an avatar using both video and audio input. Method 500 is entered into at step 502, for example, by a user initiating a local system 100. At step 504, a user selects inputs as both video input from camera 110 and audio input from microphone 120. In one embodiment, step 504 is automatically performed.

At step 506, the video and audio quality is assessed. If the video and/or audio quality is not sufficient, then an error is given at step 508 and the method terminates. For example, in one embodiment there are minimum thresholds for frame rate and number of pixels. In another embodiment, the synchronization of the video and audio inputs can also be tested and included in step 506. Thus, if one or both inputs do not meet the minimum quality requirements, then an error is given at step 508. In one embodiment, the user can be prompted to verify quality, such as for synchronization. In other embodiments, this can be automated.

At step 510 it is determined if a person is in camera view. If not, then an error is given at step 508. If a person is identified as being in view, then the person's key physical features are identified at step 512. In one embodiment, for example because audio is one of the inputs, the face, nose and mouth must be identified.

In one embodiment, no error is given at step 508 if the user steps into and/or out of view, so long as the system is able to identify the user for a minimum combined period of time and/or number of frames at step 510. In one embodiment, people and other moving objects may appear intermittently on screen and the model is able to distinguish and track the appropriate user to model without requiring further input from the user. An example of this is a mother with young children who decide to play a game of chase at the same time the mother creation her avatar.

In one embodiment, if it is determined that there is more than one person in view at step 510, then a user can be prompted to select which person to model and then proceed to step 512. One example of this is in CCTV footage where only one person is actually of interest. Another example is where is where the user is in a public place such as a restaurant or on a train.

In another embodiment, when there is more than one person in view, the method assumes that simultaneous models will be created for each person and proceeds to step 510. In one embodiment, all of the people in view are to be modeled and an avatar created for each. In this embodiment, a unique avatar model is created for each person. In one embodiment, each user is required to follow all of the steps required for a single user. For example, if reading from a script is required, then each actor must read from the script.

In one embodiment, a static 3D model is built at step 514 ahead of a dynamic model and trajectories at step 516. In another embodiment, steps 514 and 516 are performed as a single step.

At step 518, the user is instructed to perform certain tasks. In one embodiment, at step 518 the user is asked to read aloud from a script that appears on a screen so that the model can capture and model the user's voice and facial movements together as each letter, word and phrase is stated. In one embodiment, video, audio and text are modeled together during script-reading at step 518.

In one embodiment, step 518 also requires the user to express emotions including anger, elation, agreement, fear, and boredom. In one embodiment, a database 520 of reference emotions is queried to verify the user's actions as accurate.

At step 522, the model generates and maps facial cues to audio, and text if applicable. In one embodiment, the cues and mapping information gathered at step 522 enable the model to determine during later animation whether video and audio inputs are synchronized, and also to enables the model to ensure outputs are synchronized. The information gathered at step 522 also sets the stage for audio to become the avatar's driving input.

At step 524, it is determined whether the base trajectory set is adequate. In one embodiment, this step requires input from the user. In another embodiment, this step is automatically performed. If the trajectories are adequate, then in one embodiment, at step 528 a database 180 is updated. If the trajectories are not adequate, then more video is required at step 526 and processed until step 524 is satisfied.

Once the user and their behavior have been adequately modeled for the avatar, the method ends at step 530.

Modeling Body Regions

One contemplated implementation defines regions of the body by relative range of motion and/or complexity to model to expedite avatar creation.

In one embodiment, only the face of the user is modeled. In another embodiment, the face and neck is modeled. In another embodiment, the shoulders are also included. In another embodiment, the hair is also modeled. In another embodiment, additional aspects of the user can be modeled, including the shoulders, arms and torso. Other embodiments include other body parts such as waist, hips, legs, and feet.

In one embodiment, the full body of the user is modeled. In one embodiment, the details of the face and facial motion are fully modeled as well as the details of hair, hair motion and the full body. In another embodiment, the details of both the face and hair are fully modeled, while the body itself is modeled with less detail.

In another embodiment, the face and hair are modeled internally, while the body movement is taken from a generic database.

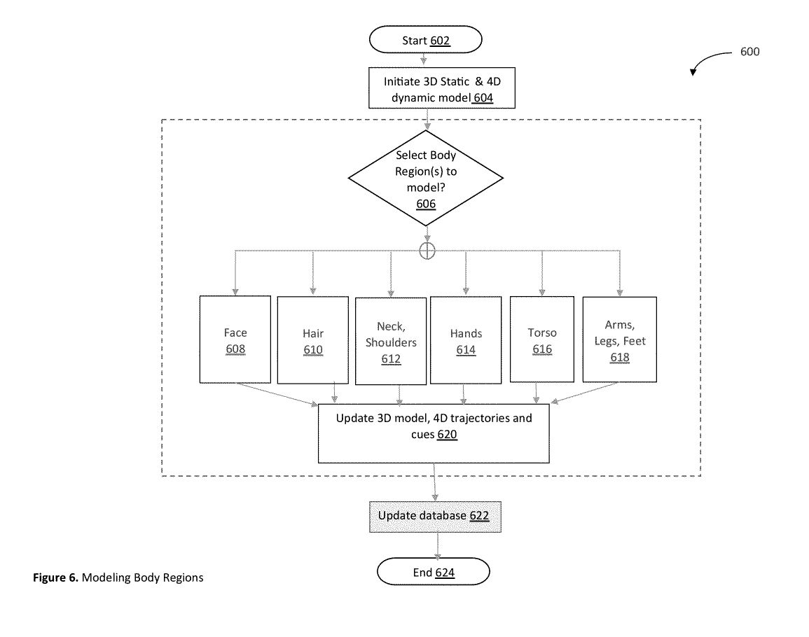

FIG. 6 is a flow diagram illustrating a method for defining regions of the body by relative range of motion and/or complexity to model. Method 600 is entered at step 602. At step 604, an avatar creation method is initiated. At step 606, the region(s) of the body are selected that require 3D and 4D modeling.

Steps 608-618 represent regions of the body that can be modeled. Step 608 is for a face. Step 610 is for hair. Step 612 is for neck and/or shoulders. Step 614 is for hands. Step 616 is for torso. Step 618 is for arms, legs and/or feet. In other embodiments, regions are defined and grouped differently.

In one embodiment, steps 608-610 are performed in sequence. In another embodiment the steps are performed in parallel.

In one embodiment, each region is uniquely modeled. In another embodiment, a best match against a reference database can be done for one or more body regions in steps 608-618.

At step 620, the 3D model, 4D trajectories and cues are updated. In one embodiment, step 620 can be done all at once. In another embodiment, step 620 is performed as and when the previous steps are performed.

At step 622, database 180 is updated. The method to define and model body regions ends at step 624.

Real-Time Hair Modeling

One contemplated implementation to achieve a photorealistic, lifelike avatar is to capture and emulate the user's hair in a manner that is indistinguishable from real hair, which includes both physical appearance (including movement) and behavior.

In one embodiment, hair is modeled as photorealistic static hair, which means that animated avatar does not exhibit secondary motion of the hair. For example, in one embodiment the avatar's physical appearance, facial expressions and movements are lifelike with the exception of the avatar's hair, which is static.

In one embodiment, the user's hair is compared to reference database, a best match identified and then used. In another embodiment, a best match approach is taken and then adjustments made.

In one embodiment, the user's hair is modeled using algorithms that result in unique modeling of the user's hair. In one embodiment, the user's unique hair traits and movements are captured and modeled to include secondary motion.

In one embodiment, the facial hair and head hair are modeled separately. In another embodiment, hair in different head and facial zones is modeled separately and then composited. For example, one embodiment can define different facial zones for eyebrows, eyelashes, mustaches, beards/goatees, sideburns, and hair on any other parts of the face or neck.

In one embodiment, head hair can be categorized by length, texture or color. For example, one embodiment categorizes hair by length, scalp coverage, thickness, curl size, thickness, firmness, style, and fringe/bangs/facial occlusion. One embodiment, the hair model can allow for different colors and tones of hair, including multi-toned, individual strands differing from others (e.g. frosted, highlights, gray), roots different from the ends, highlights, lowlights and so very many possible combinations.

In one embodiment, hair accessories are modeled, and can range from ribbons to barrettes to scarves to jewelry and allow for variation in color, material. For example, one embodiment can model different color, material and reflective properties.

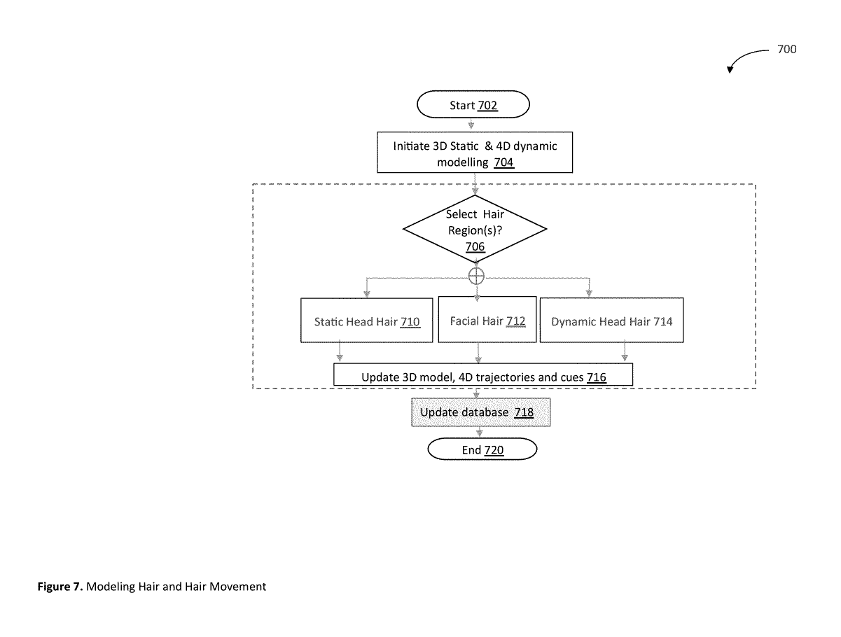

FIG. 7 is a flow diagram that illustrates a method for modeling hair and hair movement of the avatar. Method 700 is entered at step 702. At step 704, a session is initiated for the 3D static and 4D dynamic hair modeling.

At step 706, the hair region(s) to be modeled are selected. In one embodiment, step 706 requires user input. In another embodiment, the selection is performed automatically. For example, in one embodiment, only the facial hair needs to be modeled because only the avatar's face will be inserted into a video game and the character is wearing a hood covers the head.

In one embodiment, hair is divided into three categories and each category is modeled separately. At step 710, static head hair is modeled. At step 712, facial hair is modeled. At step 714, dynamic hair is modeled. In one embodiment, steps 710-714 can be performed in parallel. In another embodiment, the steps can be performed in sequence. In one embodiment, one or more of these steps can reference a hair database to expedite the step.

In step 710, static head hair is the only category that does not exhibit any secondary movement, meaning it only moves with the head and skin itself. In one embodiment, static head hair is short hair that is stiff enough not to exhibit any secondary movement, or hair that is pinned back or up and may be sprayed so that not a single hair moves. In one embodiment, static hairpieces clipped or accessories placed onto static hair can also be included in this category. As an example, in one embodiment, a static hairpiece can be a pair of glasses resting on top of the user's the head.

In step 712, facial hair, while generally short in length, moves with the muscles of the face and/or the motion of the head or external forces such wind. In particular, eyelashes and eyebrows generally move, in whole or in part, several times every few seconds. Other examples of facial hair include beards, mustaches and sideburns, which all move when a person speaks and expresses themselves through speech or other muscle movement. In one embodiment, hair fringe/bangs are included with facial hair.

In step 714, dynamic hair, such as a woman's long hair, whether worn down or in a ponytail, or even a long man's beard, will move in a more fluid manner and requires more complex modeling algorithms. In one embodiment, head scarves, dynamic accessories positioned on the head

At step 716, the hair model is added to the overall 3D avatar model with 4D trajectories. In one embodiment, the user can be prompted whether to save the model as a new model. At step 718, a database 180 is updated.

Once hair modeling is complete, the method ends at step 538.

Eye Movement and Behavior

In one embodiment, the user's eye movement and behavior is modeled. There are a number of commercially available products that can be employed such those from as Tobii or Eyefluence, or this can be internally coded.

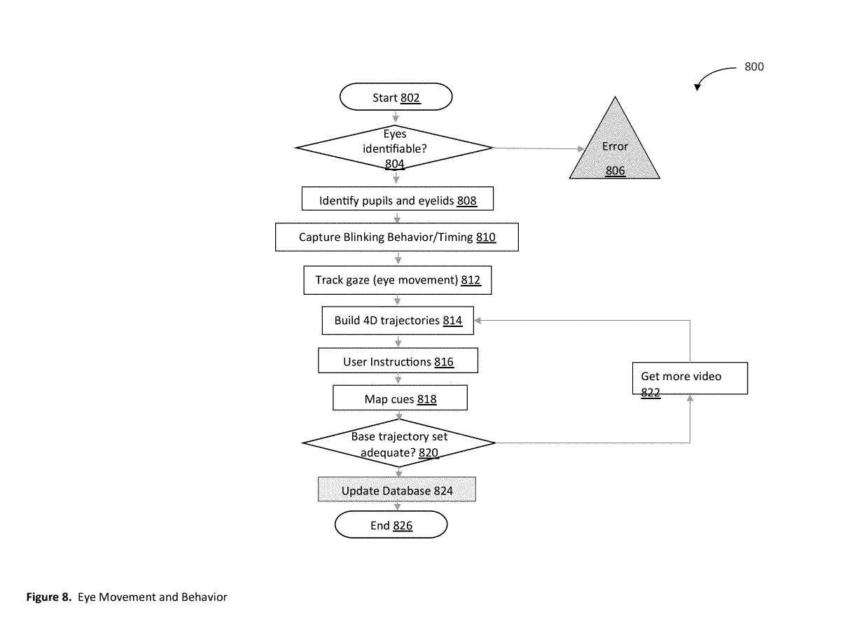

FIG. 8 is a flow diagram that illustrates a method for capturing eye movement and behavior. Method 800 is entered at step 802. At step 804 a test is performed whether the eyes are identifiable. For example, if the user is wearing glasses or a large portion of the face is obstructed, then the eyes may not be identifiable. Similarly, if the user is in view, but the person is standing too far away such that the resolution of the face makes it impossible to identify the facial features, then the eyes may not be identifiable. In one embodiment, both eyes are required to be identified at step 804. In another embodiment, only one eye is required at step 804. If the eyes are not identifiable, then an error is given at step 806.

At step 808, the pupils and eyelids are identified. In one embodiment where only a single eye is required, one pupil and corresponding eyelid is identified at step 808.

At step 810, the blinking behavior and timing is captured. In one embodiment, the model captures the blinking behavior and eye movement when speaking, thinking and listening, for example, in order to better emulate the actions of the user.

At step 812, eye movement is tracked. In one embodiment, the model captures the eye movement when speaking, thinking and listening, for example, in order to better emulate the actions of the user. In one embodiment, gaze tracking can be used as an additional control input to the model.

At step 814, trajectories are built to emulate the user's blinking behavior and eye movement.

At step 816, the user can be given instructions regarding eye movement. In one embodiment, the user can be instructed to look in certain directions. For example, in one embodiment, the user is asked to look far left, then far right, then up, then down. In another embodiment where there is also audio input, the user can be prompted with other or additional instructions to state a phrase, cough or sneeze, for example.

At step 818, eye behavior cues are mapped to the trajectories.

Once eye movement modeling has been done, a test as to the trajectory set's adequacy is performed at step 820. In one embodiment, the user is prompted for approval. In another embodiment the test is automatically performed. If not, the more video is required at step 822 and processed until the base trajectory set is adequate at 820.

At step 824, a database 180 can be updated with eye behavior information. In one embodiment, once sufficient eye movement and gaze tracking information have been obtained, it can be used to predict the user's actions in future avatar animation. In another embodiment, it can be used in a standby or pause mode during live communication.

Once enough eye movement and behavior has been obtained, the method ends at step 826.

Real-Time Modifying the Avatar

One contemplated implementation allows the user to edit their avatar. This feature enables the user to remove slight imperfections such as acne, or change physical attributes of the avatar such as hair, nose, gender, teeth, age and weight.

In one embodiment, the user is also able to alter the behavior of the avatar. For example, the user can change the timing of blinking. Another example is removing a tic or smoothing the behavior.

In one embodiment this can be referred to as a vanity feature. For example, user is given an option to improve their hair, including style, color, shine, extending (e.g. lengthening or bringing receding hairline to original location). Moreover, some users can elect to save edits for different looks (e.g. professional vs. social).

In one embodiment, this 3D editing feature can be used by cosmetic surgeons to illustrate the result of physical cosmetic surgery, with the added benefit of being able to animate the modified photorealistic avatar to dynamically demonstrate the outcome of surgery.

One embodiment of enables buyers to visualize themselves in glasses, accessories, clothing and other items as well as dynamically trying out a new hairstyle.

In one embodiment, the user is able to change the color, style and texture of the avatar's hair. This is done in real-time with animation so that the user can quickly determine suitability.

In another embodiment, the user can elect to remove wrinkles and other aspects of age or weight.

Another embodiment allows the user to change skin tone, apply make-up, reduce pore size, and extend, remove, trim or move facial hair. Examples include extending eyelashes, reducing nose or eyebrow hair.

In one embodiment, in addition to editing a photorealistic avatar, additional editing tools are available to create a lifelike fictional character, such as a furry animal.

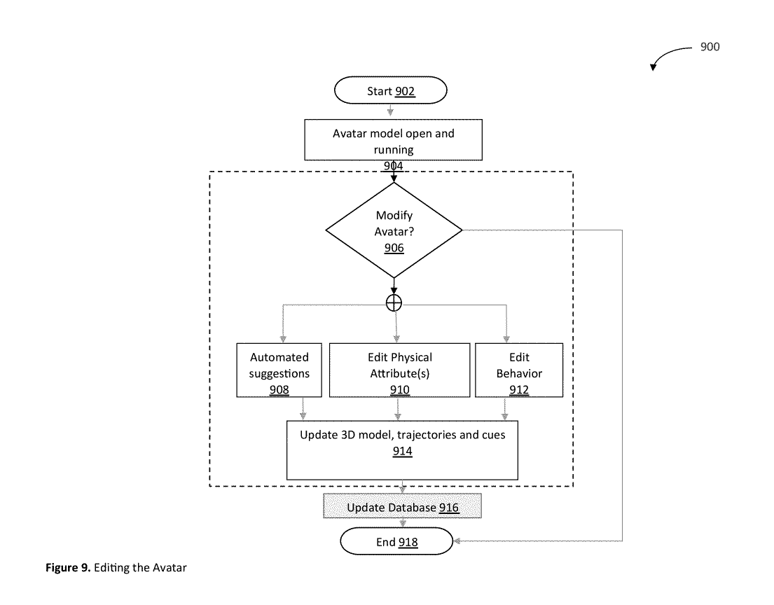

FIG. 9 is a flow diagram illustrating a method for real-time modifying a 3D avatar and its behavior. Method 900 is entered into at step 902. At step 904, the avatar model is open and running At step 906, options are given to modify the avatar. If no editing is desired then the method terminates at 918. Otherwise, there are three options available to select in steps 908-912.

At step 908, automated suggestions are made. In one example, the model might detect facial acne and automatically suggest a skin smoothing to delete the acne.

At step 910, there are options to edit physical appearance and attributes of the avatar. On example of this is the user may wish to change the hairstyle or add accessories to the avatar. Other examples include extending hair over more of the scalp or face, or editing out wrinkles or other skin imperfections. Other examples are changing clothing or even the distance between eyes.

At step 912, an option is given to edit the behavior of the avatar. One example of this is the timing of blinking, which might be useful to someone with dry eyes. In another example, the user is able to alter their voice, including adding an accent to their speech.

At step 914, the 3D model is updated, along with trajectories and cues that may have changed as a result of the edits.

At step 916, a database 180 is updated. The method ends at step 918.

Updates and Real-Time Improvements

In one embodiment, the model is improved with use, as more video input provides for greater detail and likeness, and improves cues and trajectories to mimic expressions and behaviors.

In one embodiment, the avatar is readily animated in real-time as it is created using video input. This embodiment allows the user to visually validate the photorealistic features and behaviors of the model. In this embodiment, the more time the user spends creating the model, the better the likeness because the model automatically self-improves.

In another embodiment, a user spends minimal time initially creating the model and the model automatically self-improves during use. One example of this improvement occurs during real-time animation on a video conference call.

In yet another embodiment, once the user has completed the creation process, no further improvements are made to the model unless initiated by the user.

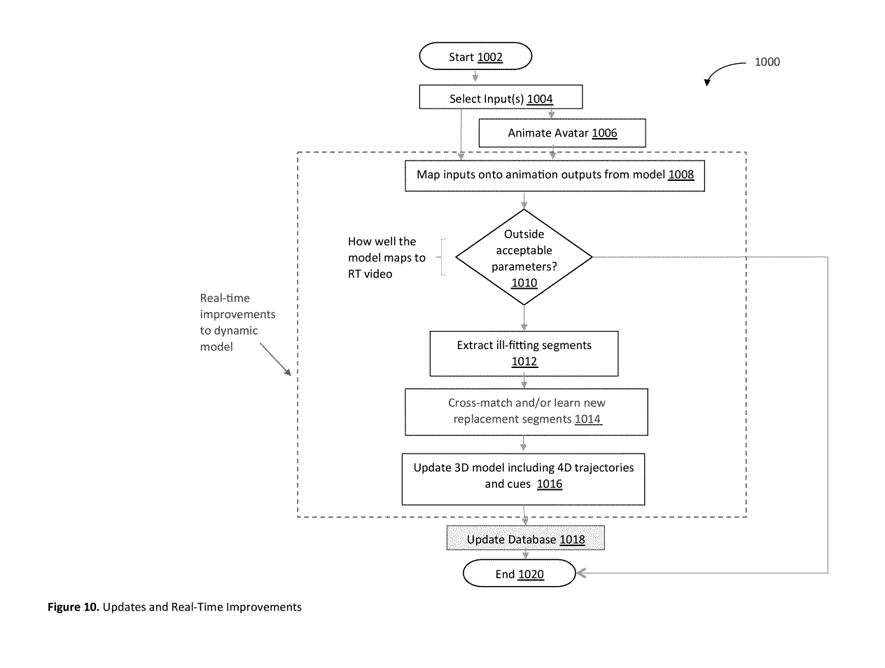

FIG. 10 is a method illustrating real-time updates and improvements to a dynamic 3D avatar model. Method 1000 is entered at step 1002. At step 1004, inputs are selected. In one embodiment, the inputs must be live inputs. In another embodiment, recorded inputs are accepted. In one embodiment, the inputs selected at step 1004 do not need to be the same inputs that were initially used to create the model. Inputs can be video and/or audio and/or text. In one embodiment, both audio and video are required at step 1004.

At step 1006, the avatar is animated by the inputs selected at step 1004. At step 1008, the inputs are mapped to the outputs of the animated model in real-time. At step 1010, it is determined how well the model maps to new inputs and if the mapping falls within acceptable parameters. If so, then the method terminates at step 1020. If not, then the ill-fitting segments are extracted at step 1012.

At step 1014, these ill-fitting segments are cross-matched and/or new replacement segments are learned from inputs 1004.

At step 1016, the Avatar model is updated as required, including the 3D model, 4D trajectories and cues. At step 1018, database 180 is updated. The method for real-time updates and improvements ends at step 1020.

Recorded Inputs

One contemplated implementation includes recorded inputs for creation and/or animation of the avatar in methods 400 and 500. Such an instance can include recorded CCTV video footage with or without audio input. Another example derives from old movies, which can include both video and audio, or simple video.

Another contemplated implementation allows for the creation of a photorealistic avatar with input being a still image such as a photograph.

In one embodiment, the model improves with additional inputs as in method 1000. One example of improvement results from additional video clips and photographs being introduced to the model. In this embodiment, the model improves with each new photograph or video clip. In another embodiment, inputting both video and sound improves the model over using still images or video alone.

Adapting to and Tracking User's Physical and Behavioral Changes in Time

One contemplated implementation adapts to and tracks user's physical changes and behavior over time for both accuracy of animation and security purposes, since each user's underlying biometrics and behaviors are more unique than a fingerprint.

In one embodiment, examples of slower changes over time include weight gain, aging, puberty-related changes to voice, physique and behavior, while more dramatic step changes resulting from plastic surgery or behavioral changes after an illness or injury.

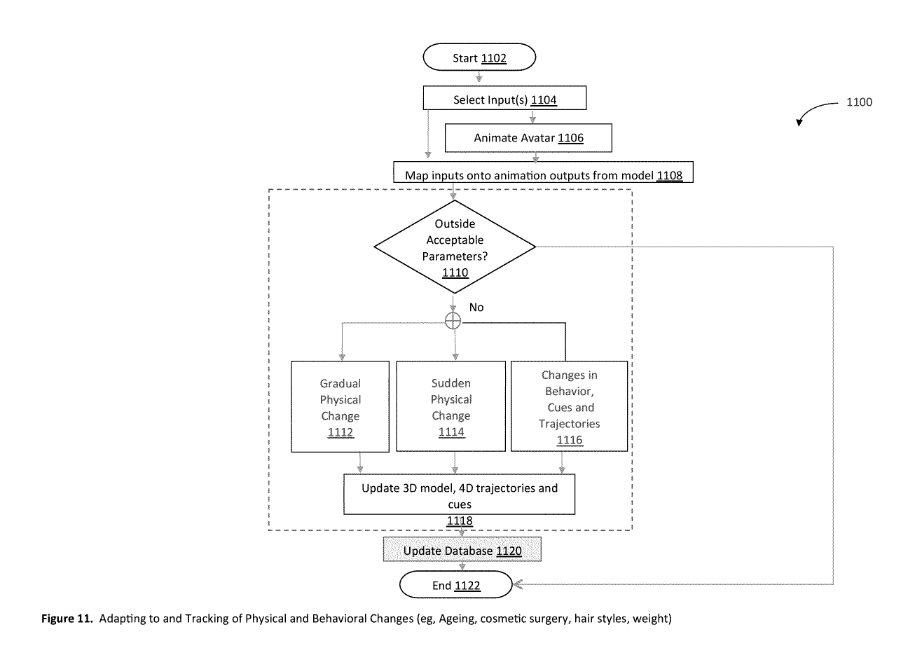

FIG. 11 is a flow diagram of a method that adapts to physical and/or behavioral changes of the user. Method 1100 is entered at step 1102. At step 1104, inputs are selected. In one embodiment, only video input I required at 1104. In another embodiment, both video and audio are required inputs at step 1104.

At step 1106, the avatar is animated using the selected inputs 1104. At step 1108, the inputs at step 1104 are mapped and compared to the animated avatar outputs from 1106. At step 1110, f the differences are within acceptable parameters, the method terminates at step 1122.

If the differences are not within acceptable parameters at step 1110, then one or more of steps 1112, 1114 and 1116 are performed. In one embodiment, if too drastic a change has occurred there can be another step added after step 1110, where the magnitude of change is flagged and the user is given an option to proceed or create a new avatar.

At step 1112, gradual physical changes are identified and modeled. At step 1114, sudden physical changes are identified and modeled. For example, in one embodiment both steps 1112 and 1114 makes note of the time that has elapsed since creation and/or the last update, capture biometric data and note the differences. While certain datasets will remain constant in time, others will invariable change with time.

At step 1116 changes in behavior are identified and modeled.

At step 1118, the 3D model, 4D trajectories and cues are updated to include these changes.

At step 1120, a database 180 is updated. In one embodiment, the physical and behavior changes are added in periodic increments, making the data a powerful tool to mine for historic patterns and trends, as well as serve in a predictive capacity.

The method to adapt to and track a user's changes ends at step 1112.

Audio Reduction

In one embodiment, a live audio stream is synchronized to video during animation. In another embodiment, audio input is condensed and stripped of inaudible frequencies to reduce the amount of data transmitted.

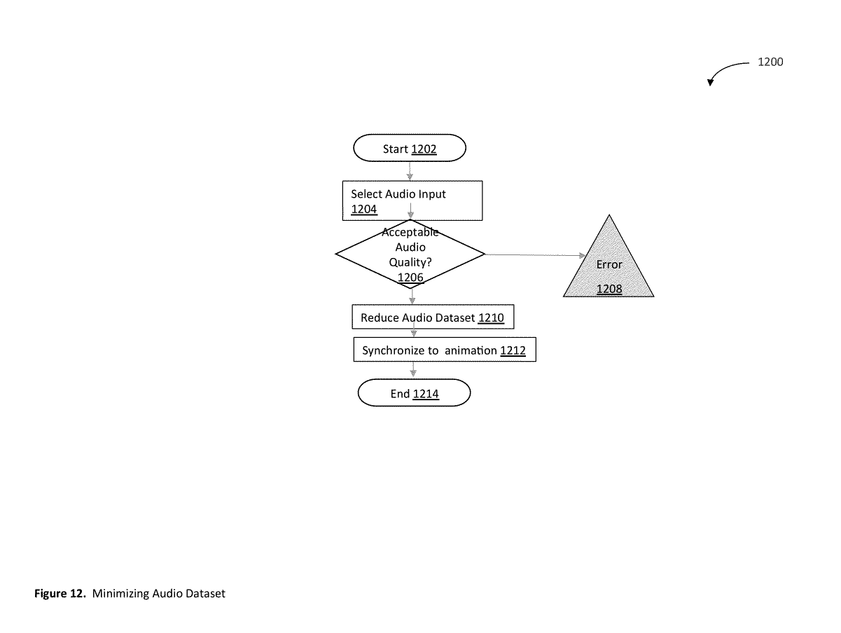

FIG. 12 is a flow diagram of a method to minimize an audio dataset. Method 1200 is entered at step 1202. At step 1204, audio input is selected. At step 1206, the audio quality is checked. If audio does not meet the quality requirement, then an error is given at step 1208. Otherwise, proceed to step 1210 where the audio dataset is reduced. At step 1212, the reduced audio is synchronized to the animation. The method ends at step 1214.

Background Noises, Other Voices

In one embodiment, only the user's voice comprises the audio input during avatar creation and animation.

In one embodiment, background noises can be reduced or filtered from the audio signal during animation In another embodiment, background noises from any source, including other voices can be reduced or filtered out.

Examples of background noises can include animal sounds such as a barking dog, birds, or cicadas. Another example of background noise is music, construction or running water. Other examples of background noise include conversations or another person speaking, for example in a public place such as a coffee shop, on a plane or in a family's kitchen.

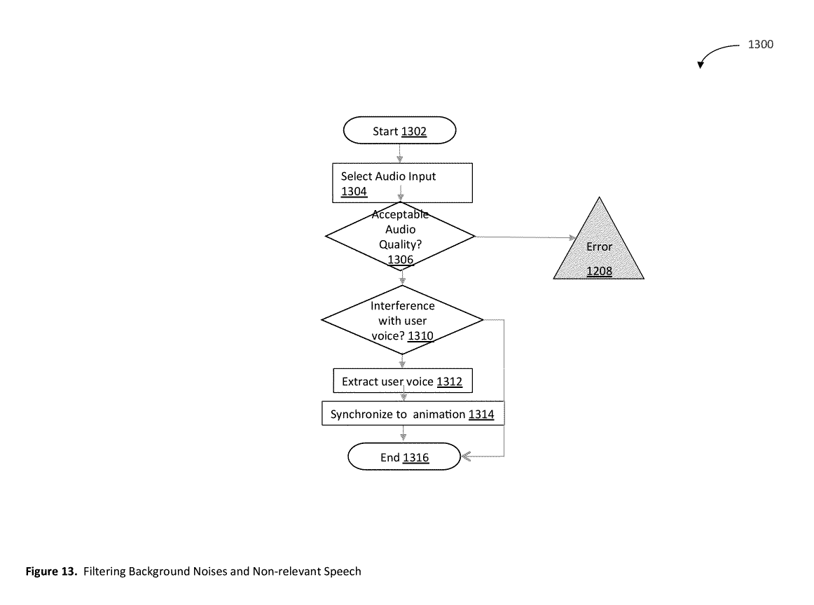

FIG. 13 is a flow diagram illustrating a method for filtering out background noises, including other voices. Method 1300 is entered at step 1302. At step 1304, audio input is selected. In one embodiment, step 1304 is done automatically. At step 1306, the quality of the audio is checked. If the quality is not acceptable, then an error is given at 1208.

If the audio quality is sufficient at 1306, then at step 1310, the audio dataset is checked for interference and extra frequencies to the user's voice. In one embodiment, a database 180 is queried for user voice frequencies and characteristics.

At step 1312, the user's voice is extracted from the audio dataset. At step 1314 the audio output is synchronized to avatar animation. The method to filter background noises ends at step 1316.

Dealing with Occlusions

In one embodiment, there are no occlusions present during avatar creation. For example, in one embodiment, the user initially creates the avatar with the face fully free of occlusions, with hair pulled back, a clean face with no mustache, beard or sideburns, and no jewelry or other accessories.

In one embodiment, occlusions are filtered out during animation of the avatar. For example, in one embodiment, a hand sweeping in front of the face can ignore the hand and animate the face as though the hand was never present.

In one embodiment, once the model is created, a partial occlusion during animation such as a hand sweeping in front of the face is ignored, as data from the non-obscured portion of the video input is sufficient. In another embodiment, when a portion of the relevant image is completely obstructed, an extrapolation is performed to smooth trajectories. In another embodiment, where there is a fixed occlusion such as from VR glasses covering a large portion of the face, the avatar is animated using multiple inputs such as an additional video stream or audio.

In another embodiment, when there is full obstruction of the image for more than a brief moment, the model can rely on other inputs such as audio to act as the primary driver for animation.

In one embodiment, a user's hair may partially cover the user face either in a fixed position or with movement of the head.

In one embodiment, whether there is a dynamic, fixed or combinations of occlusions, the avatar model is flexible enough to be able to adapt. In one embodiment, augmentation or extrapolation techniques when animating an avatar are used. In another embodiment, algorithmic modeling is used. In another embodiment, a combination of algorithms, extrapolations and substitute and/or additional inputs are used.

In one embodiment, where there is more than one person in view, then body parts of another user in view can be an occlusion for the user, which can include another person's hair, head or hand.

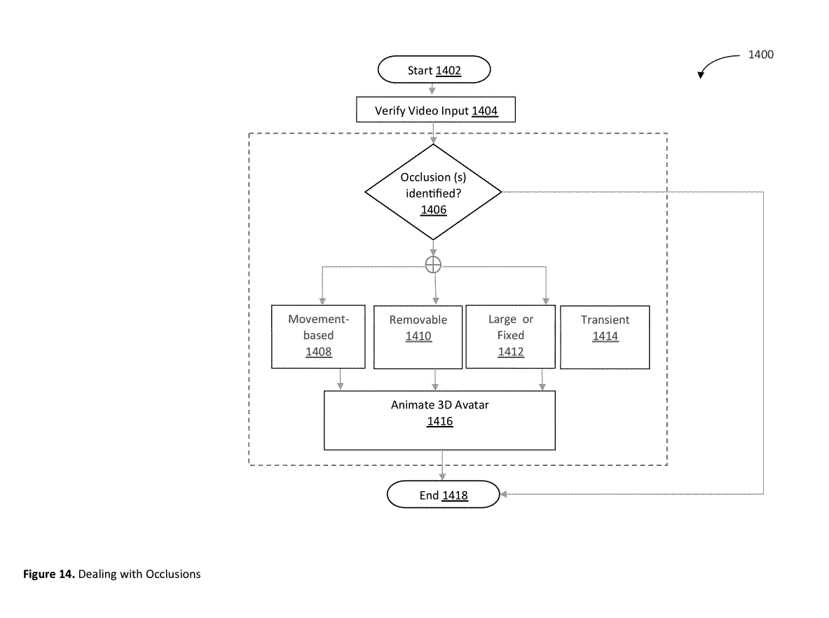

FIG. 14 is a flow diagram illustrating a method to deal with occlusions. Method 1400 is entered at step 1402. At step 1404, video input is verified. At step 1406, it is determined whether occlusion(s) exist in the incoming video. If no occlusions are identified, then the method ends at step 1418. If one or more occlusions are identified, then one or more of steps 1408, 1410 and 1412 are performed.

At step 1408 movement-based occlusions are addressed. In one embodiment, movement-based occlusions are occlusions that originate from the movement of the user. Examples of movement-based occlusions include a user's hand, hair, clothing, and position.

At step 1410, removable occlusions are addressed. In one embodiment, removable occlusions are items that can be added once removed from the user's body, such as glasses or a headpiece.

At step 1412, large or fixed occlusions are addressed. Examples include fixed lighting and shadows. In one embodiment, VR glasses fall into this category.

At step 1414, transient occlusions are addressed. In one embodiment, examples included in this category include transient lighting on a train and people or objects passing in and out of view.

At step 1416, the avatar is animated. The method for dealing with occlusions ends at step 1418.

Real-Time Avatar Animation Using Video Input

In one embodiment, an avatar animated using video as the driving input. In one embodiment, both video and audio inputs are present, but the video is the primary input and the audio is synchronized. In another embodiment, no audio input is present.

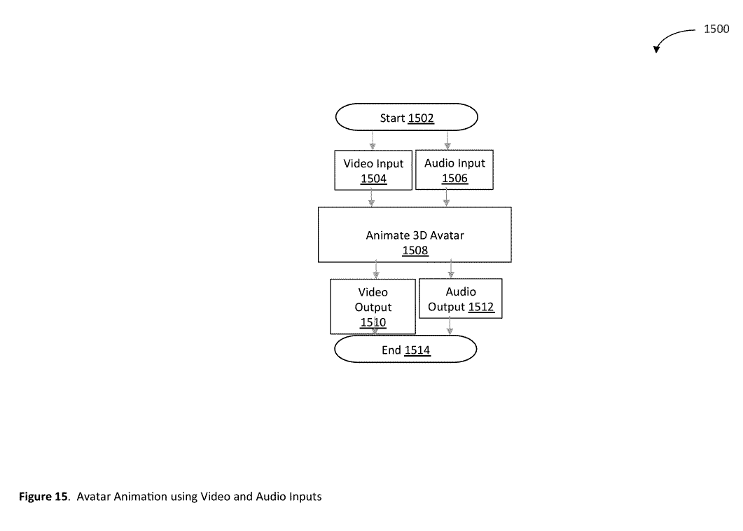

FIG. 15 is a flow diagram illustrating avatar animation with both video and audio. Method 1500 is entered at step 1502. At step 1504, video input is selected. At step 1506, audio input is selected. In one embodiment, video 1504 is the primary (master) input and audio 1506 is the secondary (slave) input.

At step 1508, a 3D avatar is animated. At step 1510, video is output from the model. At step 1512, audio is output from the model. In one embodiment, text output is also an option.

The method for animating a 3D avatar using video and audio ends at step 1514.

Real-time Avatar Animation Using Video Input (Lip Reading for Audio Output)

In one embodiment where only video input is available or audio input drops to an inaudible level, the model is able to output both video and audio by employing lip reading protocols. In this case, the audio is derived from lip reading protocols, which can derive from learned speech via the avatar creation process or by employing existing databases, algorithms or code.

One example of existing lip reading software is Intel's Audio Visual Speech Recognition software available under open source license. In one embodiment, aspects of this or other existing software is used.

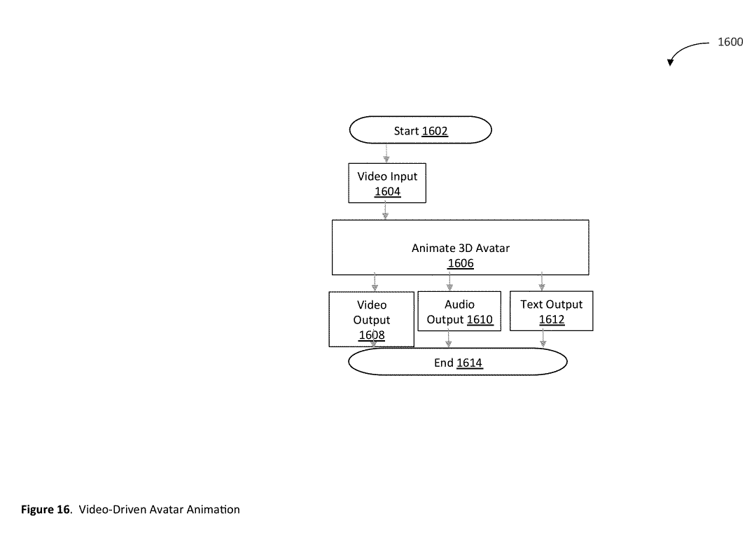

FIG. 16 is a flow diagram illustrating avatar animation with only video. Method 1600 is entered at step 1602. At step 1604, video input is selected. At step 1606, a 3D avatar is animated. At step 1608, video is output from the model. At step 1610, audio is output from the model. At step 1612, text is output from the model. The method for animating a 3D avatar using video only ends at step 1614.

Real-Time Avatar Animation Using Audio Input

In one embodiment, an avatar is animated using audio as the driving input. In one embodiment, no video input is present. In another embodiment, both audio and video are present.

One contemplated implementation takes the audio input and maps the user's voice sounds via the database to animation cues and trajectories in real-time, thus animating the avatar with synchronized audio.

In one embodiment, audio input can produce text output. An example of audio to text that is commonly used for dictation is Dragon software.

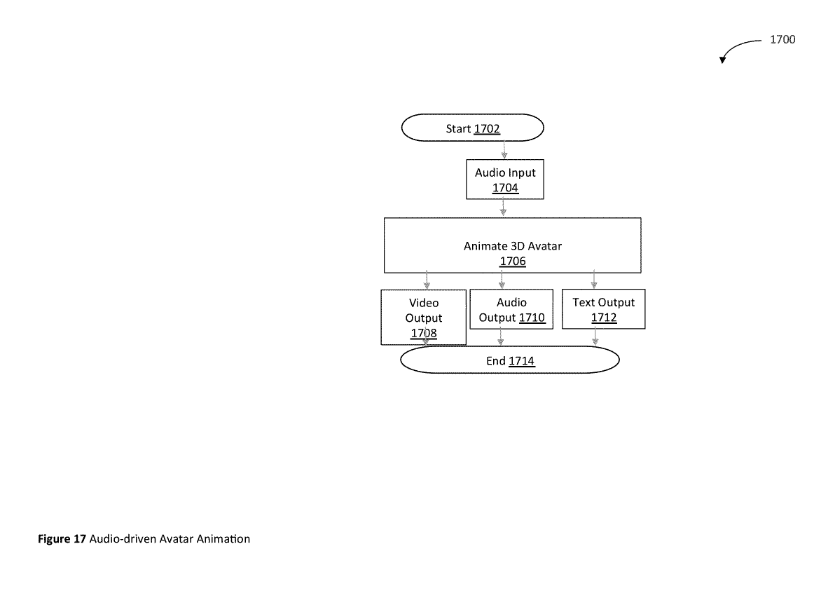

FIG. 17 is a flow diagram illustrating avatar animation with only audio. Method 1700 is entered at step 1702. At step 1704, audio input is selected. In one embodiment, the quality of the audio is assessed and if not adequate, an error is given. As part of the audio quality assessment, it is important that the speech is clear and not too fast or dissimilar to the quality of the audio when the avatar was created. In one embodiment, and option to edit the audio is given. Examples of edits include altering the pace of speech, changing pitch or tone, adding or removing and accent, filtering out background noises, or even changing the language out altogether via translation algorithms.

At step 1706, a 3D avatar is animated. At step 1708, video is output from the model. At step 1710, audio is output from the model. At step 1712, text is an optional output from the model. The method for animating a 3D avatar using video only ends at step 1714.

In one embodiment, the trajectories and cues generated during avatar creation must derive from both video and audio input such that there can be sufficient confidence in the quality of the animation when only audio is input.

Real-Time Avatar Hybrid Animation Using Video and Audio Inputs

In one embodiment, both audio and video can interchange as the driver of animation.

In one embodiment, the input with the highest quality at any given time is used as the primary driver, but can swap to the other input. One example is a scenario where the video quality is intermittent. In this case, when the video stream is good quality, it is the primary driver. However, if the video quality degrades or drops completely, then the audio becomes the driving input until video quality improves.

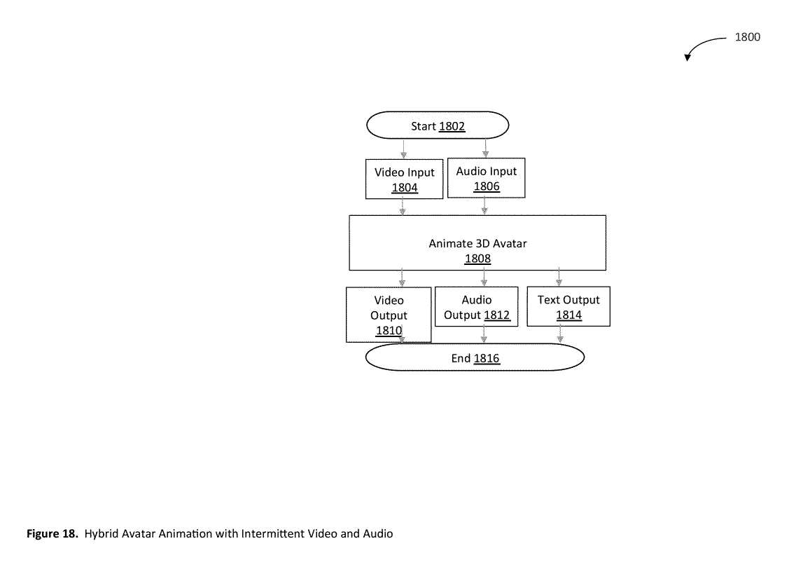

FIG. 18 is a flow diagram illustrating avatar animation with both video and audio, where the video quality may drop below usable level. Method 1800 is entered at step 1802. At step 1804, video input is selected. At step 1806, audio input is selected.

At step 1808, a 3D avatar is animated. In one embodiment, video 1804 is used as a driving input when the video quality is above a minimum quality requirement. Otherwise, avatar animation defaults to audio 1806 as the driving input.

At step 1810, video is output from the model. At step 1812, audio is output from the model. At step 1814, text is output from the model. The method for animating a 3D avatar using video and audio ends at step 1816.

In one embodiment, this hybrid approach is used for communication where, for example, a user is travelling, on a train or plane, or when the user is using a mobile carrier network where bandwidth fluctuates.

Real-Time Avatar Animation Using Text Input

In one embodiment, text is input to the model, which is used to animate the avatar and output video and text. In another embodiment, text input animates the avatar and outputs video, audio and text.

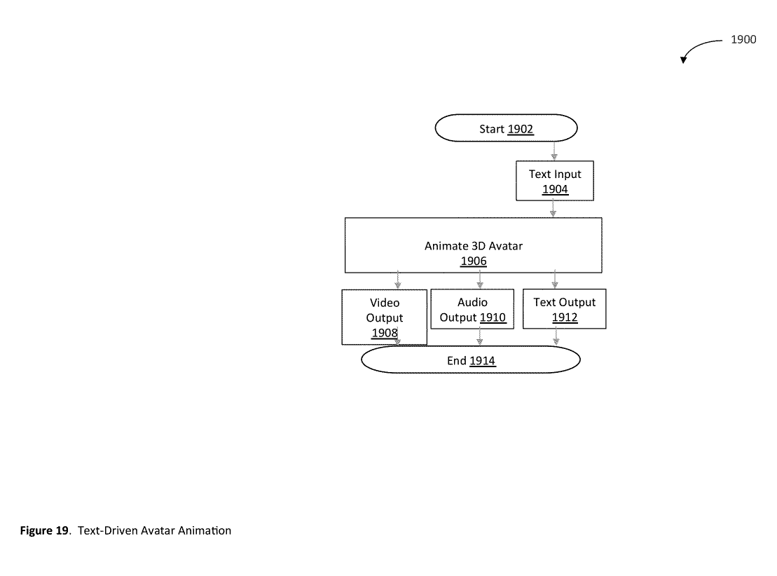

FIG. 19 is a flow diagram illustrating avatar animation with only audio. Method 1900 is entered at step 1902. At step 1904, text input is selected. At step 1906, a 3D avatar is animated. At step 1908, video is output from the model. At step 1910, audio is output from the model. At step 1912, text is an output from the model. The method for animating a 3D avatar using video only ends at step 1914.

Avatar Animation is I/O Agnostic

In one embodiment, it does not matter whether the driving input is video, audio, text, or a combination of inputs, the output can be any combination of video, audio or text.

Background Selection

In one embodiment a default background is used when animating the avatar. As the avatar exists in a virtual space, in effect the default background replaces the background in the live video stream.

In one embodiment, the user is allowed to filter out aspects of the video, including background. In one embodiment, the user can elect to preserve the background of the live video stream and insert the avatar into the scene.

In another embodiment, the user is given a number of 3D background options.

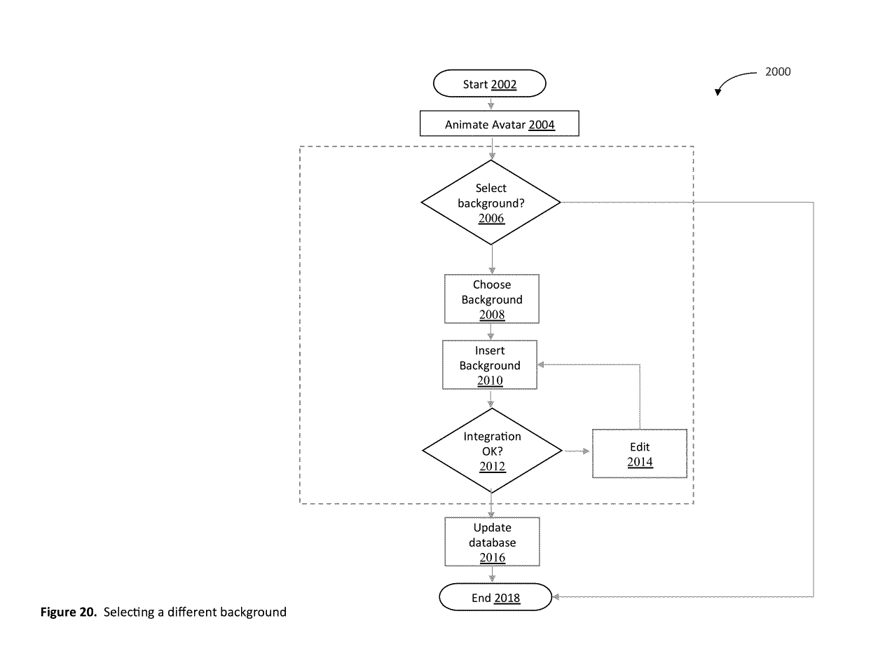

FIG. 20 is a flow diagram illustrating a method to select a background for display when animating a 3D avatar. Method 2000 is entered at step 2002.

At step 2004, the avatar is animated. In one embodiment, at least one video input is required for animation. At step 2006, an option is given to select a background. If no, then the method ends at step 2018.

At step 2008, a background is selected. In one embodiment, the background is chosen from a list of predefine backgrounds. In another embodiment, a user is able to create a new background, or import a background from external software.

At step 2010, a background is added. In one embodiment, the background chosen in step 2010 is a 3D virtual scene or world. In another embodiment a flat or 2D background can be selected.

At step 2012, it is determined whether the integration was acceptable. In one embodiment, step 2012 is automated. In another embodiment, a user is prompted at step 2012.

At step 2014, the background is edited if integration is not acceptable. Example edits include editing/adjusting the lighting, the position/location of an avatar within a scene, and other display parameters.

At step 2016, a database 180 is updated. In one embodiment, the background and/or integration is output to a file or exported.

The method to select a background ends at step 2018.

In one embodiment, method 2000 is done as part of editing mode. In another embodiment, method 2000 is done during real-time avatar creation, or during/after editing.

Animating Multiple People in View

In one embodiment, each person in view can be distinguished and a unique 3D avatar model created for each person in real-time, and animate the correct avatar for each person. In one embodiment, this is done using face recognition and tracking protocols.

In one embodiment, each person's relative position is maintained in the avatar world during animation. In another embodiment, new locations and poses can be defined for each person's avatar.

In one embodiment, each avatar can be edited separately.

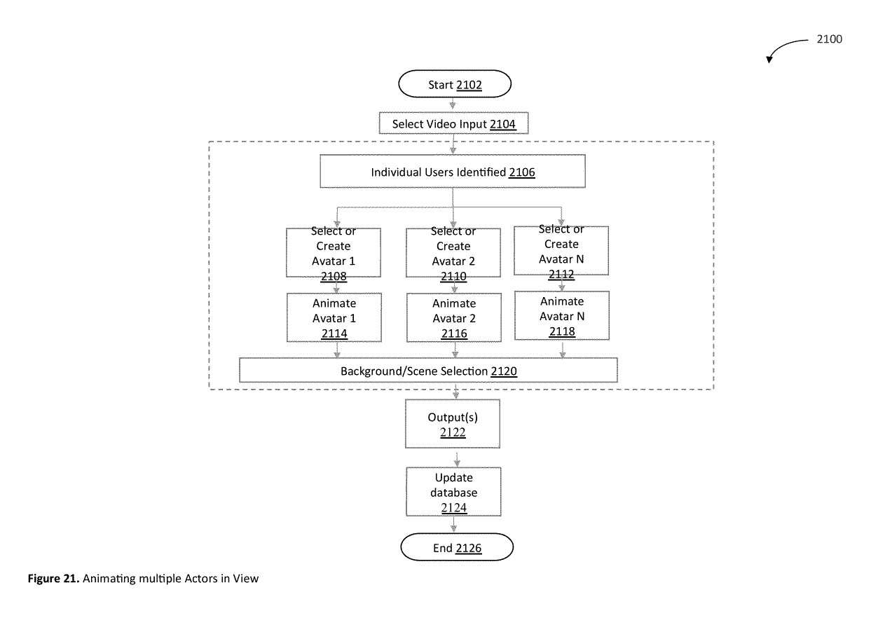

FIG. 21 is a flow diagram illustrating a method for animating more than one person in view. Method 2100 is entered at step 2102. At step 2104, video input is selected. In one embodiment, audio and video are selected at step 2104.

At step 2106, each person in view is identified and tracked.

At steps 2108, 2110, and 2112, each person's avatar is selected or created. In one embodiment, a new avatar is created in real-time for each person instead of selecting a pre-existing avatar to preserve relative proportions, positions and lighting consistency. At step 2108, the avatar of user 1 is selected or created. At step 2110, the avatar of user 2 is selected or created. At step 2112, an avatar for each additional user up to N is selected or created.

At steps 2114, 2116, and 2118, an avatar is animated for each person in view. At step 2114, the avatar of user 1 is animated. At step 2116, the avatar of user 2 is animated. At step 2118, an avatar for each additional user up to N is animated.

At step 2120, a background/scene is selected. In one embodiment, as part of scene selection, individual avatars can be repositioned or edited to satisfy scene requirements and consistency. Examples of edits include position in the scene, pose or angle, lighting, audio, and other display and scene parameters.

At step 2122, a fully animated scene is available and can be output directly as animation, output to a file and saved or exported for use in another program/system. In one embodiment, each avatar can be output individually, as can be the scene. In another embodiment, the avatars and scene are composited and output or saved

At step 2124, database 180 is updated. The method ends at step 2126.

In one embodiment, a method similar to method 2100 is used to distinguish and model user's voices.

Combining Avatars Animated in Different Locations into Single Scene

In one embodiment, users in disparate locations can be integrated into a single scene or virtual space via the avatar model. In one embodiment, this requires less processor power than stitching together live video streams.

In one embodiment, each user's avatar is placed the same virtual 3D space. An example of the virtual space can be a 3D boardroom, with avatars seated around the table. In one embodiment, each user can change their perspective in the room, zoom in on particular participants and rearrange the positioning of avatars, each in real-time.

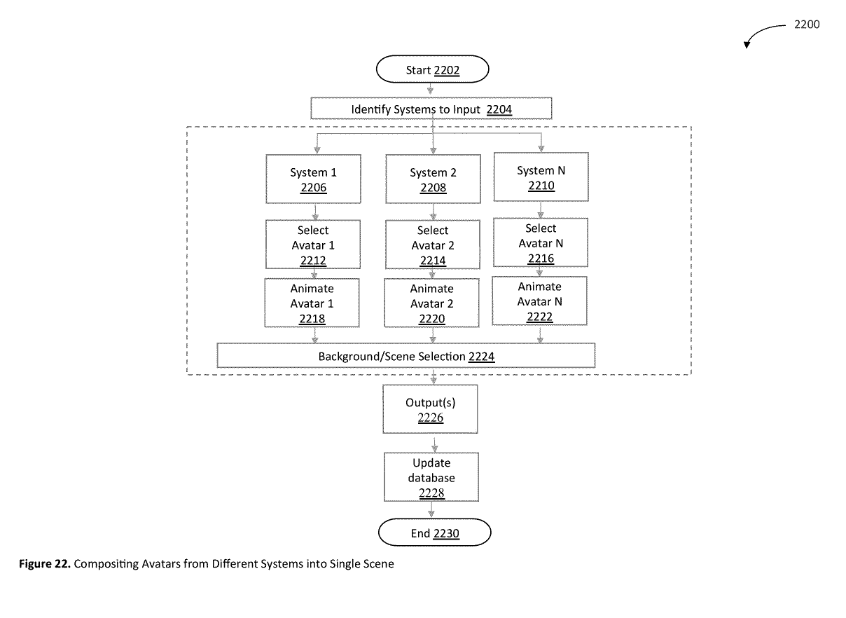

FIG. 22 is a flow diagram illustrating a method to combine avatars animated in different locations or on different local systems into a single view or virtual space. Method 2200 is entered at step 2202.

At step 2204, all systems with a user's avatar to be composited are identified and used as inputs. At step 2206, system 1 is connected. At step 2208, system 2 is connected. At step 2210, system N is connected. In one embodiment, the systems are check to ensure the inputs, including audio, are fully synchronized.

At step 2212, the avatar of the user of system 1 is prepared. At step 2214, the avatar of the user of system 2 is prepared. At step 2216, the avatar of the user of system 1 is prepared. In one embodiment, this means creating an avatar. In one embodiment, it is assumed that each user's avatar has already been created and steps 2212-2216 are meant to ensure each model is ready for animation.

At steps 2218-2222, the avatars are animated. At step 2218, avatar 1 is animated. At step 2220, avatar 2 is animated. At step 2222, avatar N is animated. In one embodiment, the animations are performed live the avatars are fully synchronized with each other. In another embodiment, avatars are animated at different times.

At step 2224, a scene or virtual space is selected. In one embodiment, the scene can be edited, as well as individual user avatars to ensure there is consistency of lighting, interactions, sizing and positions, for example.

At step 2226, the outputs include a fully animated scene direct output to display and speakers and/or text, output to a file and then saved, or exported for use in another program/system. In one embodiment, each avatar can be output individually, as can be the scene. In another embodiment, the avatars and scene are composited and output or saved.

At step 2228, database 180 is updated. The method ends at step 2230.

Real-Time Communication Using the Avatar

One contemplated implementation is to communicate in real-time using a 3D avatar to represent one or more of the parties.

In traditional video communication, all parties view live video. In one embodiment, a user A can use an avatar to represent them on a video call, and the other party(s) uses live video. In this embodiment, for example, when user A is represented by an avatar, user A receives live video party B, whilst party B transmits live video but sees a lifelike avatar for user A. In one embodiment, one or more users employ an avatar in video communication, whilst other party(s) transmits live video.

In one embodiment, all parties communicate using avatars. In one embodiment, all parties use avatars and all avatars are integrated in the same scene in a virtual place.

In one embodiment, one-to-one communication uses an avatar for one or both parties. An example of this is a video chat between two friends or colleagues.

In one embodiment, one-to-many communication employs an avatar for one person and/or each of the many. An example of this is a teacher communicating to students in an online class. The teacher is able to communicate to all of the students.

In another embodiment, many-to-one communication uses an avatar for the one and the “many” each have an avatar. An example of this is students communicating to the teacher during an online class (but not other students).

In one embodiment, many-to-many communication is facilitated using an avatar for each of the many participants. An example of this is a virtual company meeting with lots of non-collocated workers, appearing and communicating in a virtual meeting room.

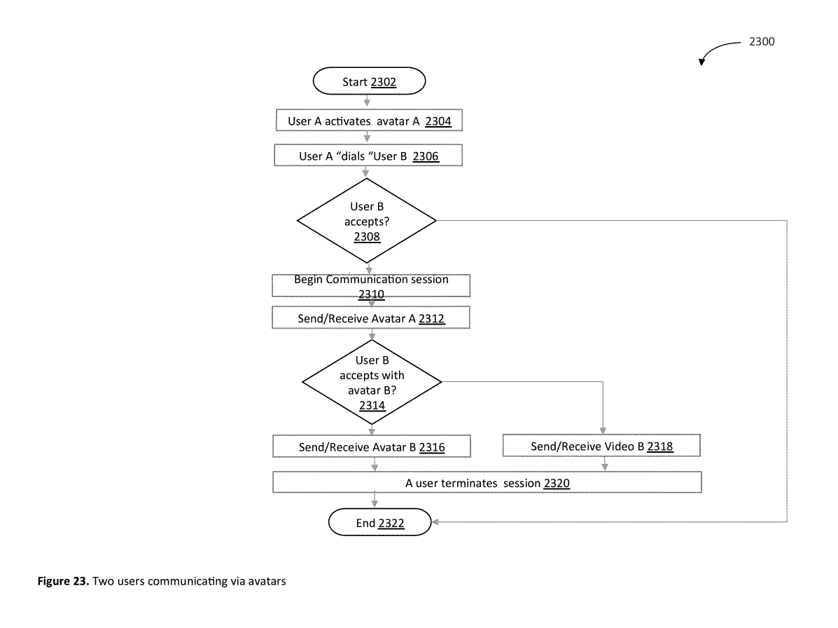

FIG. 23 is a flow diagram illustrating two users communicating via avatars. Method 2300 is entered at step 2302.

At step 2304, user A activates avatar A. At step 2306, user A attempts to contact user B. At step 2308, user B either accepts or not. If the call is not answered, then the method ends at step 2328. In one embodiment, if there is no answer or the call is not accepted at step 2306, then user A is able to record and leave a message using the avatar.

At step 2310, a communication session begins if user B accepts the call at step 2308.

At step 2312, avatar A animation is sent to and received by user B's system. At step 2314, it is determined whether user B is using their avatar B. If so, then at step 2316 avatar B animation is sent to and received by user A's system. If the user is not using their avatar at step 2312, then at step 2318, user B's live video is sent to and received by user A's system.

At step 2320, the communication session is terminated. At step 2322, the method ends.

In one embodiment, a version of the avatar model resides on both the user's local system and also a destination system(s). In another embodiment, animation is done on the user's system. In another embodiment, the animation is done in the Cloud. In another embodiment, animation is done on the receiver's system.

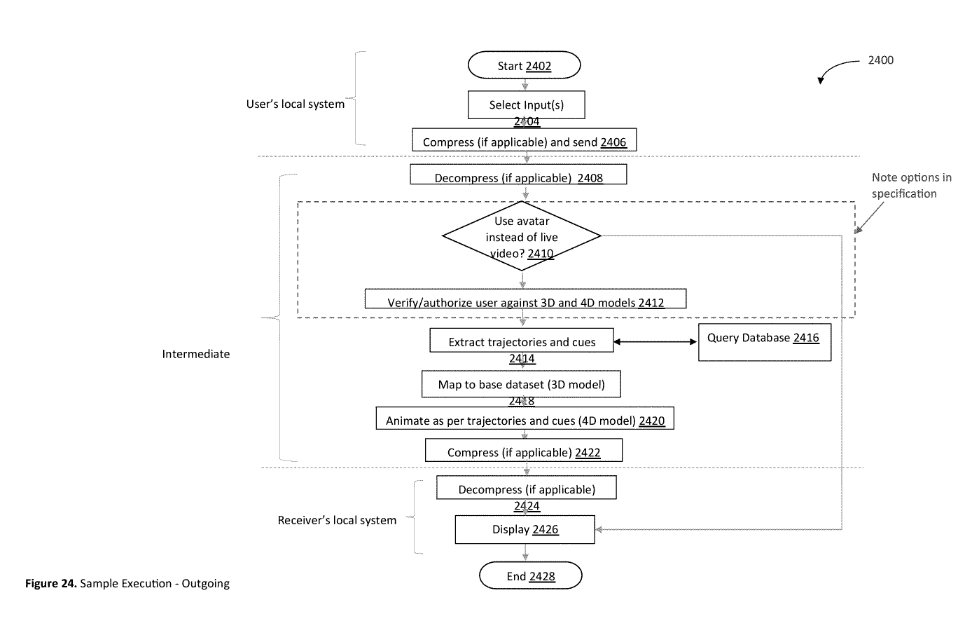

FIG. 24 is flow diagram illustrating a method for sample outgoing execution. Method 2400 is entered at step 2402. At step 2404, inputs are selected. At step 2406, the input(s) are compressed (if applicable) and sent. In one embodiment, animation computations are done on a user's local system such as a smartphone. In another embodiment, animation computations are done in the Cloud. At step 2408, the inputs are decompressed if they were compressed in step 2406.

At step 2410, it is decided whether to use an avatar instead of live video. At step 2412, the user is verified and authorized. At step 2414, trajectories and cues are extracted. At step 2416, a database is queried. At step 2418, the inputs are mapped to the base dataset of the 3D model. At step 2420, an avatar is animated as per trajectories and cues. At step 2422, the animation is compressed if applicable.

At step 2424, the animation is compressed if applicable. At step 2426, an animated avatar is displayed and synchronized with audio. The method ends at step 2428.

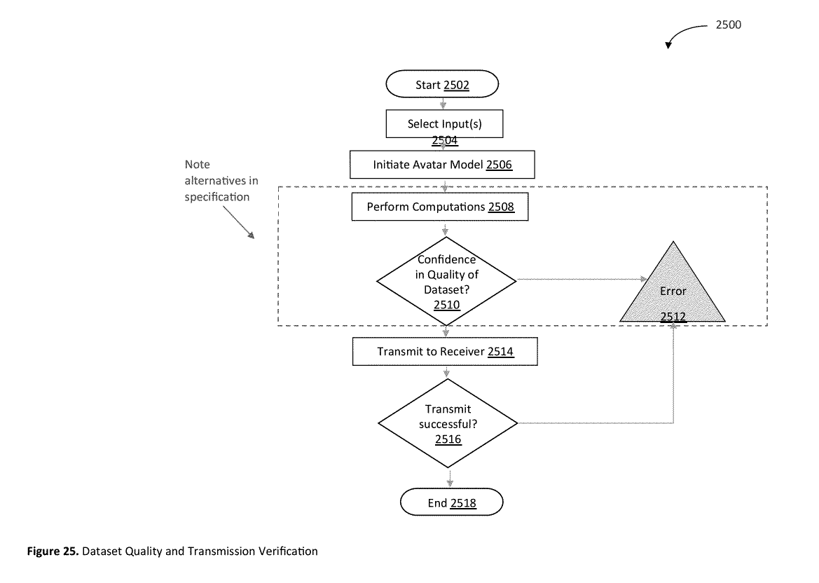

FIG. 25 is a flow diagram illustrating a method to verify dataset quality and transmission success. Method 2500 is entered at step 2502. At step 2504, inputs are selected. At step 2506, an avatar model is initiated. At step 2508, computations are performed to extract trajectories and cues from the inputs. At step 2510, confidence in the quality of the dataset resulting from the computations is determined. If no confidence, then an error is given at step 2512. If there is confidence, then at step 2514, the dataset is transmitted to the receiver system(s). At step 2516, it is determined whether the transmission was successful. If not, an error is given at step 2512. The method ends at step 2518.

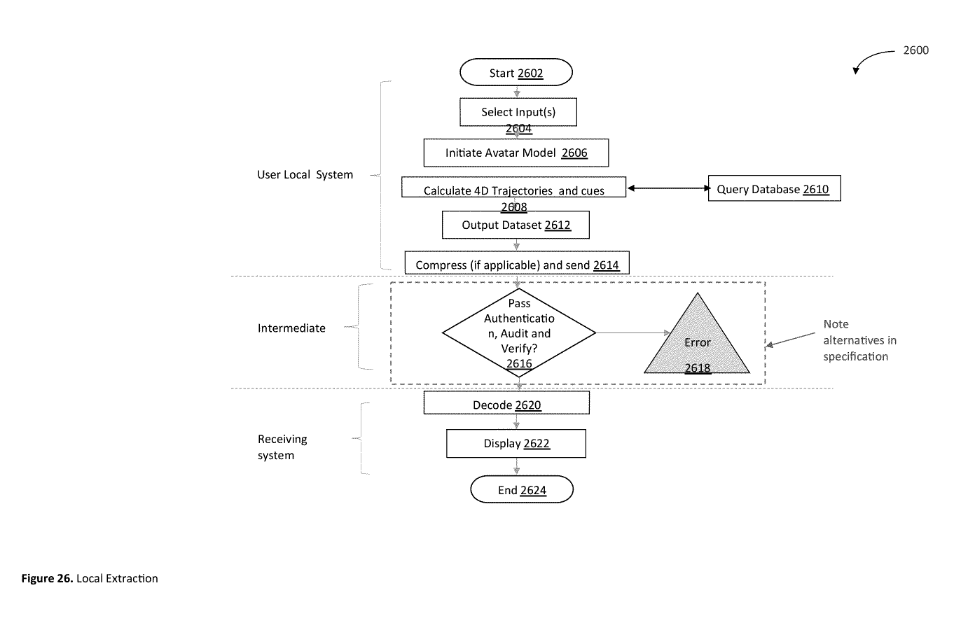

FIG. 26 is a flow diagram illustrating a method for local extraction where the computations are done on the user's local system. Method 2600 is entered at step 2602. Inputs are selected at step 2604. At step 2606, the avatar model is iniated on a user's local system. At step 2608, 4D trajectories and cues are calculated. At step 2610, a database is queried. At step 2612, a dataset it output. At step 2614, the dataset is compressed, if applicable, and sent. At step 2616, it is determined if the dataset is quality audit is successful. If not, then an error is given at step 2618. At step 2620, the dataset is decoded on the receiving system. At step 2622, an animated avatar is displayed. The method ends at step 2624.

User Verification and Authentication

In one embodiment, only the user who created the avatar can animate the avatar. This can be for one or more reasons including trust between user and audience; age appropriateness of user for a particular website; or is required by company policy; or required by law to verify the identity of the user.

In one embodiment, if the live video stream does not match the physical features and behaviors of the user, then that user is prohibited from animating the avatar.

In another embodiment, the age of the user is known or approximated. This data is transmitted to the website or computer the user is trying to access, and if the user's age does not meet the age requirement, then the user is prohibited from animating the avatar. One example is preventing a child who is trying to illegally access a pornographic website. Another example is a pedophile who is trying to pretend he is a child on social media or website.

In one embodiment, the model is able to transmit data not only regarding age, but gender, ethnicity and aspects of behavior that might raise flags as to mental illness or ill intent.

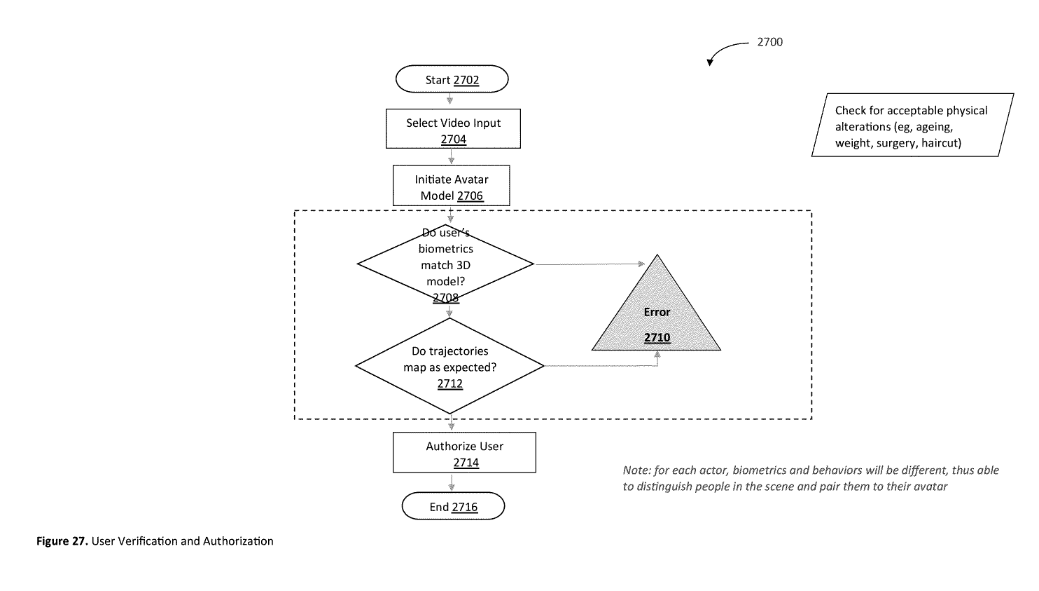

FIG. 27 is a flow diagram illustrating a method to verify and authenticate a user. Method 2700 is entered at step 2702. At step 2704, video input is selected. At step 2706, an avatar model is initiated. At step 2708, it is determined whether the user's biometrics match those in the 3D model. If not, and error is given at step 2710. At step 2712, it is determined whether the trajectories match sufficiently. If not, an error is given at step 2710. At step 2714, user is authorized. The method ends at step 2716.

Standby and Pause Modes

In one embodiment, should the bandwidth drop too low for sufficient avatar animation, the avatar will display a standby mode. In another embodiment, if the call is dropped for any reason other than termination initiated by the user, the avatar transmits a standby mode for so long as connection is lost.

In one embodiment, a user is able to pause animation for a period of time. For example, in one embodiment, a user wishes to accept another call or is distracted by something. In this example, the user would elect to pause animation for so long as the call takes or the distraction goes away.

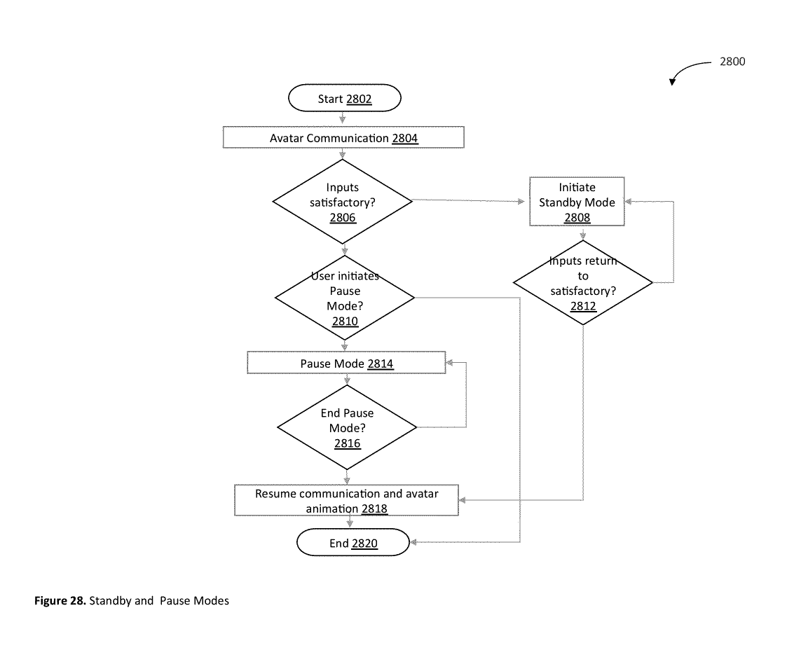

FIG. 28 is flow diagram illustrating a method to pause the avatar or put it in standby mode. Method 2800 is entered a step 2802. At step 2804, avatar communication is transpiring. At step 2806, the quality of the inputs is assessed. If the quality of the inputs falls below a certain threshold that the avatar cannot be animated to a certain standard, then at step 2808 the avatar is put into standby mode until the inputs return to satisfactory level(s) in step 2812.

If the inputs are of sufficient quality at step 2806, then there is an option for the user to pause the avatar at step 2810. If selected, the avatar is put into pause mod at step 2814. At step 2816, an option is given to end pause mode. If selected, the avatar animation resumes at step 2818. The method ends at step 2820.

In one embodiment, standby mode will display the avatar as calm, looking ahead, displaying motions of breathing and blinking. In another embodiment, the lighting can appear to dim.

In one embodiment, when the avatar goes into standby mode, the audio continues to stream. In another embodiment, when the avatar goes into standby mode, no audio is streamed.

In one embodiment, the user has the ability to actively put the avatar into a standby/pause mode. In this case, the user is able to select what is displayed and whether to transmit audio, no audio or select alternative audio or sounds.

In another embodiment, whenever the user walks out of camera view, the systems automatically displays standby mode.

Communication Using Different Driving Inputs

In one contemplated implementation, a variety of driving inputs for animation and communication are offered. Table 1 outlines these scenarios, which were previously described herein.

TABLE 1
Animation and communication I/O Scenarios

| | | | | Model Generated Outputs | | |
|---|---|---|---|---|---|---|
| | Inputs | | | Output | Output | Output |
| Scenario | Video | Audio | Text | 1 | 2 | 3 |
| Standard | Video | Audio | | Video | Audio | Text |
| Video Driven | Video | | | Video | Audio | Text |
| (Lip Reading) | | | | | | |
| Audio Driven | | Audio | | Video | Audio | Text |
| Text Driven | | | Text | Video | Audio | Text |
| Hybrid | Video | Audio | | Video | Audio | Text |

MIMO Multimedia Database

In one embodiment of a multiple input—multiple output database, user-identifiable data is indexed as well as anonymous datasets.

For example, user-specific information in the database includes user's physical features, age, gender, race, biometrics, behavior trajectories, cues, aspects of user audio, hair model, user modifications to model, time stamps, user preferences, transmission success, errors, authentications, aging profile, external database matches.

In one embodiment, only data pertinent to the user and user's avatar is stored in a local database and generic databases reside externally and are queried as necessary.

In another embodiment, all information on a user and their avatar model are saved in a large external database, alongside that of other users, and queried as necessary. In this embodiment, as the user's own use increases and the overall user base grows, the database can be mined for patterns and other types of aggregated and comparative information.

In one embodiment, when users confirm relations with other users, the database is mined for additional biometric, behavioral and other patterns. In this embodiment, predictive aging and reverse aging within a bloodline is improved.

Artificial Intelligence Applications

In one embodiment, the database and datasets within can serve as a resource for artificial intelligence protocols.

Output To Printer

In one embodiment, any pose or aspect of the 3D model, in any stage of the animation can be output to a printer. In one embodiment, the whole avatar or just a body part can be output for printing.

In one embodiment, the output is to a 3D printer as a solid piece figurine. In another embodiment, the output to a 3D printer is for a flexible 3D skin. In one embodiment, there are options to specify materials, densities, dimensions, and surface thickness for each avatar body part (e.g. face, hair, hand).

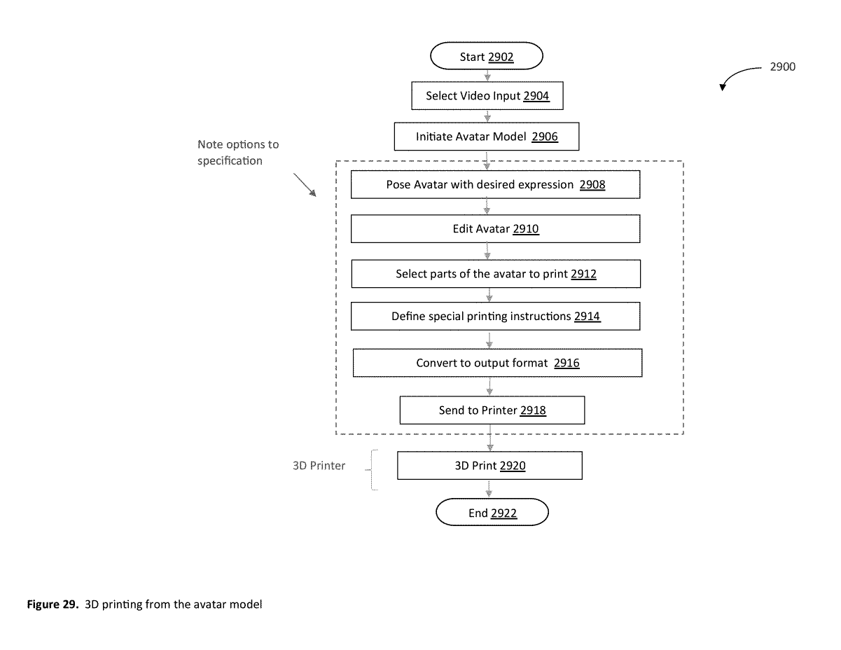

FIG. 29 is a flow diagram illustrating a method to output from the avatar model to a 3D printer. Method 2900 is entered at step 2902. At step 2904, video input is selected. In one embodiment, another input can be used, if desired. At step 2906, an avatar model is initiated. At step 2908, a user poses the avatar with desired expression. At step 2910, the avatar can be edited. At step 2912, a user selects which part(s) of the avatar to print. At step 2914, specific printing instructions are defined. For example, if the hair is to be printed of a different material than the face.

At step 2916, the avatar pose selected is converted to an appropriate output format. At step 2918, the print file is sent to a 3D printer. At step 2920, the printer prints the avatar as instructed. The method ends at step 2922.

Output to Non-2D Displays

In one embodiment, there are many ways to visualize the animated avatar beyond 2D displays, including holographic projection, 3D Screens, spherical displays, dynamic shapes and fluid materials. Options include light-emitting and light-absorbing displays. There are options for fixed and portable display as well as options for non-uniform surfaces and dimensions.

In one embodiment, the model output to dynamic screens and non-flat screens. Examples include output to a spherical screen. Another example is to a shape-changing display. In one embodiment, the model outputs to a holographic display.

In on embodiment, there are options for portable and fixed displays in closed and open systems. There is an option for life-size dimensions, especially where an observer is able to view the avatar from different angles and perspectives. In one embodiment, there is an option to integrate with other sensory outputs.

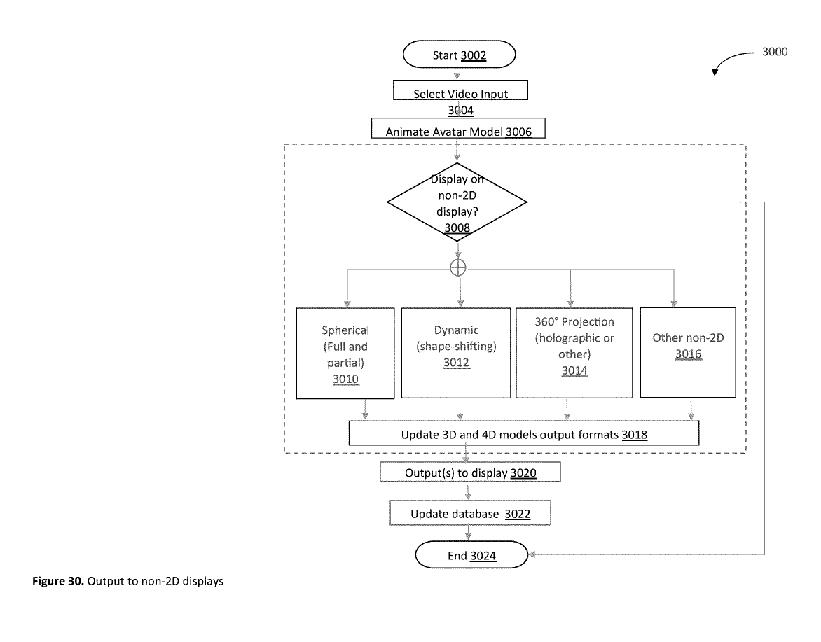

FIG. 30 is a flow diagram illustrating a method to output from the avatar model to non-2D displays. Method 3000 is entered at step 3002. At step 3004, video input is selected. At step 3006, an avatar model is animated. At step 3008, and option is given to output to a non-2D display. At step 3008, there is an option to display on a non-2D screen. At step 3010, a format to output to spherical display is generated. At step 3012, a format is generated to output to a dynamic display. At step 3014, a format is generated to output to a holographic display. At step 3016, a format can be generated to output to other non-2D displays. At step 3018, updates to the avatar model are performed, if necessary. At step 3020, the appropriate output is sent to the non-2D display. At step 3022, updates to the database are made if required. The method ends at step 3024.

Animating a Robot

One issue that exists with video conferencing is presence. Remote presence via a 2D computer screen lacks aspects of presence for others with whom the user is trying to communicate.

In one embodiment, the likeness of the user is printed onto a flexible skin, which is wrapped onto a robotic face. In this embodiment, the 3D avatar model outputs data to the electromechanical system to effect the desired expressions and behaviors.

In one embodiment, the audio output is fully synchronized to the electromechanical movements of the robot, thus achieving a highly realistic android.

In one embodiment, only the facial portion of a robot is animated. One embodiment includes a table or chair mounted face. Another embodiment adds hair. Another embodiment adds the head to a basic robot such as one manufactured by iRobot.

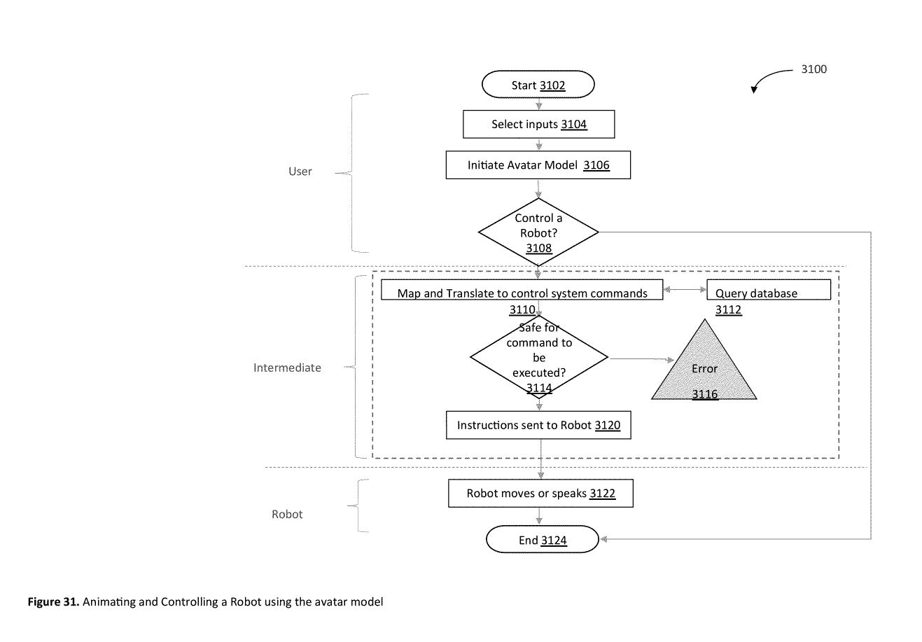

FIG. 31 is a flow diagram illustrating a method to animate and control a robot using a 3D avatar model. Method 3100 is entered at step 3102. At step 3104, inputs are selected. At step 3106, an avatar model is initiated. At step 3108, an option is given to control a robot. At step 3110, avatar animation trajectories are mapped and translated to robotic control system commands. At step 3112, a database is queried. At step 3114, the safety of a robot performing commands is determined. If not safe, an error is given at step 3116. At step 3120, instructions are sent to the robot. At step 3122, the robot takes action by moving or speaking. The method ends at step 3124.

In one embodiment, animation computations and translating to robotic commands is performed on a local system. In another embodiment, the computations are done in the Cloud. Note that there are additional options to the specification as outlined in method 3100.

According to some but not necessarily all embodiments, there is provided: A system, comprising: input devices which capture audio and video streams from a first user's actual appearance and movements; a first computing system which receives video and audio data from the input devices, and accordingly generates, according to a known model, an animated photorealistic 3D avatar with trajectories and cues for animation, which substantially replicates appearance, gestures, and inflections of the first user in real time; and a second computing system, remote from said first computing system, which uses said trajectories and cues to reconstruct a photorealistic real-time 3D avatar, in accordance with the known model, which varies, in accordance with said trajectories and cues, to match the appearance, gestures, inflections of the first user, and outputs said avatar to be shown on a display to a second user; wherein the known model includes time-dependent trajectories for at least some elements of the user's dynamically simulated appearance.

According to some but not necessarily all embodiments, there is provided: A method, comprising: capturing audio and video streams from a first user's actual appearance and movements, and accordingly generating, according to a known model, a first animated photorealistic 3D avatar which, with associated trajectories and cues for animation, substantially replicates gestures, inflections, and general appearance of the first user in real time; and transmitting the trajectories and cues for animation; and receiving, from a second computing system, trajectories and cues to reconstruct a second photorealistic real-time 3D avatar in accordance with the known model, and reconstructing the second avatar, and displaying the reconstructed avatar to the first user; wherein the known model includes time-dependent trajectories for at least some elements of a user's dynamically simulated appearance.

According to some but not necessarily all embodiments, there is provided: A system, comprising: input devices which capture audio and video streams from a first user's actual appearance and movements; a first computing system which receives video and audio data from the input devices, and accordingly generates, according to a known model, a data stream which uses a known avatar model to define an animated photorealistic 3D avatar which replicates gestures, inflections, and general appearance of the first user in real time; and a second computing system, remote from said first computing system, which uses said data stream and said known model to reconstruct a photorealistic real-time 3D avatar which replicates gestures, inflections, and general appearance of the first user, and outputs said avatar to be shown on a display to a second user; wherein, during normal operation, the second computing system outputs said avatar with photorealism which is greater than the maximum of the uncanny valley; and wherein, if normal operation is impeded, the second computing system either outputs said avatar with photorealism which is less than the minimum of the uncanny valley, or else outputs trajectory and cues that have been predefined in sequence for such purpose.

According to some but not necessarily all embodiments, there is provided: A method, comprising: receiving a data stream which defines inflections of a photorealistic real-time 3D avatar in accordance with a known model, and reconstructing the second avatar, and either: displaying the reconstructed avatar to the user, ONLY IF the data stream is adequate for the reconstructed avatar to have a quality above the uncanny valley; or else displaying a fallback display, which partially corresponds to the reconstructed avatar, but which has a quality BELOW the uncanny valley.

According to some but not necessarily all embodiments, there is provided: A system, comprising: input devices which capture audio and video streams from a first user's actual appearance and movements; a first computing system which receives video and audio data from the input devices, and accordingly generates, according to a known model, a data stream which uses a known avatar model to define an animated photorealistic 3D avatar which replicates gestures, inflections, and general appearance of the first user in real time; a second computing system, remote from said first computing system, which uses said data stream and said known model to reconstruct a photorealistic real-time 3D avatar which replicates gestures, inflections, and general appearance of the first user, and outputs said avatar to be shown on a display to a second user; and a third computing system, remote from said first computing system, which compares the photorealistic avatar against video which is not received by the second computing system, and which accordingly provides an indication of fidelity to the second computing system; whereby the second user is protected against impersonation and material misrepresentation.

According to some but not necessarily all embodiments, there is provided: A method, comprising: capturing audio and video streams from a first user's actual appearance and movements, and accordingly generating, according to a known model, a first animated photorealistic 3D avatar which, with associated real-time data for animation, substantially replicates gestures, inflections, and general appearance of the first user in real time; transmitting said associated real-time data to a second computing system; and transmitting said associated real-time data to a third computing system, together with additional video imagery which is not sent to said second computing system; whereby the third system can assess and report on the fidelity of the avatar, without exposing the additional video imagery to a user of the second computing system.

According to some but not necessarily all embodiments, there is provided: A system, comprising: input devices which capture audio and video streams from a first user's actual appearance and movements; a first computing system which receives video and audio data from the input devices, and accordingly generates, according to a known model, a data stream which uses a known avatar model to define an animated photorealistic 3D avatar which replicates gestures, inflections, and general appearance of the first user in real time; and a second computing system, remote from said first computing system, which uses said data stream and said known model to reconstruct a photorealistic real-time 3D avatar which replicates gestures, inflections, and general appearance of the first user, and outputs said avatar to be shown on a display to a second user; wherein the first computing system generates the video aspect of said avatar in dependence on both video and audio sensing of the first user.

According to some but not necessarily all embodiments, there is provided: A system, comprising: input devices which capture audio and video streams from a first user's actual appearance and movements; a first computing system which receives video and audio data from the input devices, and accordingly generates, according to a known model, a data stream which uses a known avatar model to define an animated photorealistic 3D avatar which replicates gestures, inflections, and general appearance of the first user in real time; and a second computing system, remote from said first computing system, which uses said data stream and said known model to reconstruct a photorealistic real-time 3D avatar which replicates gestures, inflections, and general appearance of the first user, and outputs said avatar to be shown on a display to a second user; wherein the first computing system generates the video aspect of said avatar in dependence on both video and audio sensing of the first user.

According to some but not necessarily all embodiments, there is provided: A system, comprising: input devices which capture audio and video streams from a first user's actual appearance and movements; a first computing system which receives video and audio data from the input devices, and accordingly generates, according to a known model, a data stream which uses a known avatar model to define an animated photorealistic 3D avatar which replicates gestures, inflections, and general appearance of the first user in real time; and a second computing system, remote from said first computing system, which uses said data stream and said known model to reconstruct a photorealistic real-time 3D avatar which replicates gestures, inflections, and general appearance of the first user, and outputs said avatar to be shown on a display to a second user; wherein the first computing system generates the audio aspect of said avatar in dependence on both video and audio sensing of the first user.

According to some but not necessarily all embodiments, there is provided: A system, comprising: input devices which capture audio and video streams from a first user's actual appearance and movements; a first computing system which receives video and audio data from the input devices, and accordingly generates, according to a known model, a data stream which uses a known avatar model to define an animated photorealistic 3D avatar which replicates gestures, inflections, and general appearance of the first user in real time; and a second computing system, remote from said first computing system, which uses said data stream and said known model to reconstruct a photorealistic real-time 3D avatar which replicates gestures, inflections, and general appearance of the first user, and outputs said avatar to be shown on a display to a second user; wherein the first computing system generates the video aspect of said avatar in dependence on both video and audio sensing of the first user; and wherein the first computing system generates the audio aspect of said avatar in dependence on both video and audio sensing of the first user.

According to some but not necessarily all embodiments, there is provided: A method, comprising: capturing audio and video streams from a first user's actual appearance and movements, and accordingly generating, according to a known model, a first animated photorealistic 3D avatar which, with associated real-time data for voiced animation, substantially replicates gestures, inflections, utterances, and general appearance of the first user in real time; wherein the generating step sometimes uses the audio stream to help generate the appearance of the avatar, and sometimes uses the video stream to help generate audio which accompanies the avatar.

According to some but not necessarily all embodiments, there is provided: A method, comprising: capturing audio and video streams from a first user's actual appearance and movements, and accordingly generating, according to a known model, a first animated photorealistic 3D avatar which, with associated real-time data for animation, substantially replicates gestures, inflections, and general appearance of the first user in real time; wherein said generating step is optionally interrupted by the first user, at any time, to produce a less interactive simulation during a pause mode.

According to some but not necessarily all embodiments, there is provided: A method, comprising: capturing audio and video streams from a first user's actual appearance and movements, and accordingly generating, according to a known model, a first animated photorealistic 3D avatar which, with associated real-time data for animation, substantially replicates gestures, inflections, and general appearance of the first user in real time; wherein said generating step is driven by video if video quality is sufficient, but is driven by audio if the video quality is temporarily not sufficient.

Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Further aspects of embodiments of the inventions are illustrated in the attached Figures. Additional embodiments can be envisioned to one of ordinary skill in the art after reading the attached documents. In other embodiments, combinations or sub-combinations of the above disclosed inventions can be advantageously made. The block diagrams of the architecture and flow charts are grouped for ease of understanding. How ever it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention.

Any of the above described steps can be embodied as computer code on a computer readable medium. The computer readable medium can reside on one or more computational apparatuses and can use any suitable data storage technology.

The present inventions can be implemented in the form of control logic in software or hardware or a combination of both. The control logic can be stored in an information storage medium as a plurality of instructions adapted to direct an information processing device to perform a set of steps disclosed in embodiment of the present inventions. Based on the disclosure and teachings provided herein, a person of ordinary skill in the art will appreciate other ways and/or methods to implement the present inventions. A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

Additional general background, which helps to show variations and implementations, can be found in the following publications, all of which are hereby incorporated by reference: Hong et al. “Real-Time Speech-Driven Face Animation with Expressions Using Neural Networks” IEEE Transactions On Neural Networks, Vol. 13, No. 1, January 2002; Wang et al. “High Quality Lip-Sync Animation For 3D Photo-Realistic Talking Head” IEEE ICASSP 2012; Breuer et al. “Automatic 3D Face Reconstruction from Single Images or Video” Max-Planck-Institut fuer biologische Kybernetik, February 2007; Brick et al. “High-presence, low-bandwidth, apparent 3D video-conferencing with a single camera” Image Analysis for Multimedia Interactive Services, 2009. WIAMIS '09; Liu et al. “Markerless Motion Capture of Interacting Characters Using Multi-view Image Segmentation” IEEE Conference on Computer Vision and Pattern Recognition (CVPR), June 2011; Chin et al. “Lips detection for audio-visual speech recognition system” International Symposium on Intelligent Signal Processing and Communications Systems, February 2008; Cao et al. “Expressive Speech-Driven Facial Animation”, ACM Transactions on Graphics (TOG), Vol. 24 Issue 4, October 2005; Kakumanu et al. “Speech Driven Facial Animation” Proceedings of the 2001 workshop on Perceptive user interfaces, 2001; Nguyen et al. “Automatic and real-time 3D face synthesis” Proceedings of the 8th International Conference on Virtual Reality Continuum and its Applications in Industry, 2009; and Haro et al. “Real-time, Photo-realistic, Physically Based Rendering of Fine Scale Human Skin Structure” Proceedings of the 12th Eurographics Workshop on Rendering Techniques, 2001.

Additional general background, which helps to show variations and implementations, can be found in the following patent publications, all of which are hereby incorporated by reference: 2013/0290429; 2009/0259648; 2007/0075993; 2014/0098183; 2011/0181685; 2008/0081701; 2010/0201681; 2009/0033737; 2007/0263080; 2006/0221072; 2007/0080967; 2003/0012408; 2003/0123754; 2005/0031194; 2005/0248574; 2006/0294465; 2007/0074114; 2007/0113181; 2007/0130001; 2007/0233839; 2008/0082311; 2008/0136814; 2008/0159608; 2009/0028380; 2009/0147008; 2009/0150778; 2009/0153552; 2009/0153554; 2009/0175521; 2009/0278851; 2009/0309891; 2010/0302395; 2011/0096324; 2011/0292051; 2013/0226528.

Additional general background, which helps to show variations and implementations, can be found in the following patents, all of which are hereby incorporated by reference: U.S. Pat. Nos. 8,365,076; 6,285,380; 6,563,503; 8,566,101; 6,072,496; 6,496,601; 7,023,432; 7,106,358; 7,106,358; 7,671,893; 7,840,638; 8,675,067; 7,643,685; 7,643,685; 7,643,683; 7,643,671; and 7,853,085.

Additional material, showing implementations and variations, is attached to this application as an Appendix (but is not necessarily admitted to be prior art).

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A system, comprising:
input devices which capture audio and video streams from a first user's actual appearance and movements;
a first computing system which receives video and audio data from the input devices, and accordingly generates, according to a known model, an animated photorealistic 3D avatar with trajectories and cues for animation, which substantially replicates appearance, gestures, and inflections of the first user in real time; and
a second computing system, remote from said first computing system, which uses said trajectories and cues to reconstruct a photorealistic real-time 3D avatar, in accordance with the known model, which varies, in accordance with said trajectories and cues, to match the appearance, gestures, inflections of the first user, and outputs said avatar to be shown on a display to a second user;
wherein the known model includes time-dependent trajectories for at least some elements of the user's dynamically simulated appearance.

2. The system of claim 1, wherein said first computing system is a distributed computing system.

3. The system of claim 1, wherein said input devices include multiple cameras.

4. The system of claim 1, wherein said input devices include at least one microphone.

5. The system of claim 1, wherein said first computing system uses cloud computing.

6. A method, comprising:
capturing audio and video streams from a first user's actual appearance and movements, and accordingly generating, according to a known model, a first animated photorealistic 3D avatar which, with associated trajectories and cues for animation, substantially replicates gestures, inflections, and general appearance of the first user in real time; and transmitting the trajectories and cues for animation; and
receiving, from a second computing system, trajectories and cues to reconstruct a second photorealistic real-time 3D avatar in accordance with the known model, and reconstructing the second avatar, and displaying the reconstructed avatar to the first user;
wherein the known model includes time-dependent trajectories for at least some elements of a user's dynamically simulated appearance.

7. The method of claim 6, wherein said first computing system is a distributed computing system.

8. The method of claim 6, wherein said input devices include multiple cameras.

9. The method of claim 6, wherein said input devices include at least one microphone.

10. The method of claim 6, wherein said first computing system uses cloud computing.

11. A system, comprising:
input devices which capture audio and video streams from a first user's actual appearance and movements;
a first computing system which receives video and audio data from the input devices, and accordingly generates, according to a known model, a data stream which uses a known avatar model to define an animated photorealistic 3D avatar which replicates gestures, inflections, and general appearance of the first user in real time; and
a second computing system, remote from said first computing system, which uses said data stream and said known model to reconstruct a photorealistic real-time 3D avatar which replicates gestures, inflections, and general appearance of the first user, and
outputs said avatar to be shown on a display to a second user;
wherein, during normal operation, the second computing system outputs said avatar with photorealism which is greater than the maximum of the uncanny valley; and wherein, if normal operation is impeded, the second computing system either outputs said avatar with photorealism which is less than the minimum of the uncanny valley, or else outputs trajectory and cues that have been predefined in sequence for such purpose.

12. The system of claim 11, wherein said first computing system is a distributed computing system.

13. The system of claim 11, wherein said input devices include multiple cameras.

14. The system of claim 11, wherein said input devices include at least one microphone.

15. The system of claim 11, wherein said first computing system uses cloud computing.

16. The system of claim 11, wherein the known model includes time-dependent trajectories for at least some elements of a user's dynamically simulated appearance.

17-67. (canceled)
